(19) United States
(12) Patent Application Publication
(10) Pub. No.: US 2023/0345515 A1
(43) Pub. Date: Oct. 26, 2023

(54) NR SIDELINK ASSISTANCE INFORMATION MESSAGES PROCEDURES

(71) Applicant: Fraunhofer-Gesellschaft zur Förderung der angewandten Forschung e.V., München (DE)

(72) Inventors: Sarun SELVANESAN, Berlin (DE); Baris GÖKTEPE, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 18/303,475

(22) Filed: Apr. 19, 2023

Related U.S. Application Data
(63) Continuation of application No. PCT/EP2021/078125, filed on Oct. 12, 2021.

(30) Foreign Application Priority Data
Oct. 21, 2020 (EP) 20203155.5

(51) Int. Cl. H04W 72/53; H04W 72/02

(52) U.S. Cl. CPC H04W 72/53; H04W 72/02

(57) ABSTRACT

A user device, UE, for a wireless communication network, is described. The wireless communication network includes a plurality of user devices, UEs. The UE is to communicate with one or more network entities of the wireless communication network, like a base station or another UE. Responsive to a trigger for a transmission, the UE is to obtain resources for the transmission. The UE is to receive from one or more further UEs one or more reports or assistance information messages, AIMs, the report or AIM including resource allocation related assistance information. Dependent on a type of resource allocation related assistance information contained in the received report or AIM and/or dependent on a certain criterium, the UE is to decide how to use the received report or AIM for obtaining resources for the transmission.

### CROSS-REFERENCE TO RELATED APPLICATIONS

This application is a continuation of copending International Application No. PCT/EP2021/078125, filed Oct. 12, 2021, which is incorporated herein by reference in its entirety, and additionally claims priority from European Application No. 20203155.5, filed Oct. 21, 2020, which is also incorporated herein by reference in its entirety.

### TECHNICAL FIELD

The present application concerns the field of wireless communication systems or networks, more specifically, the transmission of assistance information to a user device, UE, of the wireless communication network. Embodiments of the present invention concern a user device, UE, and the procedures it follows when receiving one or more assistance information messages, AIMs, dependent on a type of the AIM.

### BACKGROUND OF THE INVENTION

FIG. 1(A) and 1(B) is a schematic representation of an example of a terrestrial wireless network 100 including, as is shown in FIG. 1(A), the core network 102 and one or more radio access networks RAN₁, RAN₂, . . . RAN_{N}. FIG. 1(B)_is a schematic representation of an example of a radio access network RAN, that may include one or more base stations gNB₁ to gNBs, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RAN₁ may include more or less such cells, and RAN₁ may also include only one base station. FIG. 1(B) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNBs may be connected to the core network 102, e.g. via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNBs may be connected, e.g. via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length. For example, in 5G a subframe has a duration of 1 ms, as in LTE. The subframe includes one or more slots, dependent on the subcarrier spacing. For example, at a subcarrier spacing of 15 kHz the subframe includes one slot, at a subcarrier spacing of 30 kHz the subframe includes two slots, at a subcarrier spacing of 60 kHz the subframe includes four slots, etc. Each slot may, in turn, include 12 or 14 OFDM symbols dependent on the cyclic prefix, CP, length.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard, or the IEEE 802.11 standard.

The wireless network or communication system depicted in FIG. 1(A) and 1(B) may be a heterogeneous network having distinct overlaid networks, e.g., a network of macro cells with each macro cell including a macro base station, like base station gNB₁ to gNB₅, and a network of small cell base stations, not shown in FIG. 1(A) and 1(B), like femto or pico base stations. In addition to the above described terrestrial wireless network also non-terrestrial wireless communication networks, NTN, exist including space borne transceivers, like satellites, and/or airborne transceivers, like unmanned aircraft systems. The non-terrestrial wireless communication network or system may operate in a similar way as the terrestrial system described above with reference to FIG. 1(A) and 1(B), for example in accordance with the LTE-Advanced Pro standard or the 5G or NR, new radio, standard, or the IEEE 802.11 standard.

In mobile communication networks, for example in a network like that described above with reference to FIG. 1(A) and 1(B), like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1(A) and 1(B). This is referred to as an “in-coverage” scenario. Another scenario is referred to as an “out-of-coverage” scenario. It is noted that “out-of-coverage” does not mean that the two UEs are not within one of the cells depicted in FIG. 1(A) and 1(B), rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station, e.g., GSM, UMTS, LTE base stations, that may not support certain service, like NR V2X services.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2(A) is a schematic representation of an in-coverage scenario in which two UEs directly communicating with each other are both connected to a base station. The base station gNB has a coverage area that is schematically represented by the circle 150 which, basically, corresponds to the cell schematically represented in FIG. 1(A) and 1(B). The UEs directly communicating with each other include a first vehicle 152 and a second vehicle 154 both in the coverage area 150 of the base station gNB. Both vehicles 152, 154 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a Mode 3 configuration in LTE V2X.

FIG. 2(B) is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 156, 158 and 160 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(B) which is the out-of-coverage scenario does not necessarily mean that the respective Mode 2 UEs in NR or mode 4 UEs in LTE are outside of the coverage 150 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 150 shown in FIG. 2(A), in addition to the NR Mode 1 or LTE Mode 3 UEs 152, 154 also NR Mode 2 or LTE mode 4 UEs 156, 158, 160 are present. In addition, FIG. 2(B), schematically illustrates an out of coverage UE using a relay to communicate with the network. For example, the UE 160 may communicate over the sidelink with UE₁ which, in turn, may be connected to the gNB via the Uu interface. Thus, UE₁ may relay information between the gNB and the UE 160

Although FIG. 2(A) and FIG. 2(B) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

It is noted that the information in the above section is only for enhancing the understanding of the background of the invention and, therefore, it may contain information that does not form known technology that is already known to a person of ordinary skill in the art.

Starting from the above, there may be a need for improvements or enhancements in the handling of assistance information by a user device.

### SUMMARY

An embodiment may have a user device, UE, for a wireless communication network, the wireless communication network including a plurality of user devices, UEs, wherein the UE is to communicate with one or more network entities of the wireless communication network, like a base station or another UE, wherein, responsive to a trigger for a transmission, the UE is to obtain resources for the transmission, wherein the UE is to receive from one or more further UEs one or more reports or assistance information messages, AIMs, the report or AIM including resource allocation related assistance information, and wherein, dependent on a type of resource allocation related assistance information contained in the received report or AIM and/or dependent on a certain criterium, the UE is to decide how to use the received report or AIM for obtaining resources for the transmission.

Another embodiment may have a wireless communication system, having one or more inventive user devices, UEs, as mentioned above.

According to another embodiment, a method for operating a user device, UE, for a wireless communication network, the wireless communication network including a plurality of user devices, UEs, wherein the UE is to communicate with one or more network entities of the wireless communication network, like a base station or another UE, may have the steps of: responsive to a trigger for a transmission, obtaining resources for the transmission, receiving from one or more further UEs one or more reports or assistance information messages, AIMs, the report or AIM including resource allocation related assistance information, and dependent on a type of resource allocation related assistance information contained in the received report or AIM and/or dependent on a certain criterium, deciding how to use the received report or AIM for obtaining resources for the transmission.

### BRIEF DESCRIPTION OF THE DRAWINGS

Embodiments of the present invention are now described in further detail with reference to the accompanying drawings, in which:

FIG. 1(A) and 1(B) is a schematic representation of an example of a terrestrial wireless network, wherein FIG. 1(A) illustrates a core network and one or more radio access networks, and FIG. 1(B) is a schematic representation of an example of a radio access network RAN;

FIG. 2(A) and 2(B) schematically represents in-coverage and out-of-coverage scenarios, wherein FIG. 2(A) is a schematic representation of an in-coverage scenario in which two UEs directly communicating with each other are both connected to a base station, and FIG. 2(B) is a schematic representation of an out-of-coverage scenario in which the UEs directly communicating with each other,

FIG. 3 illustrates a sensing process be performed by a UE autonomously selecting resources for a transmission;

FIG. 4 is a schematic representation of a wireless communication system including a transmitter, like a base station, one or more receivers, like user devices, UEs, for implementing embodiments of the present invention;

FIG. 5 schematically represents a user device, UE, in accordance with embodiments of the present invention; and

FIG. 6 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

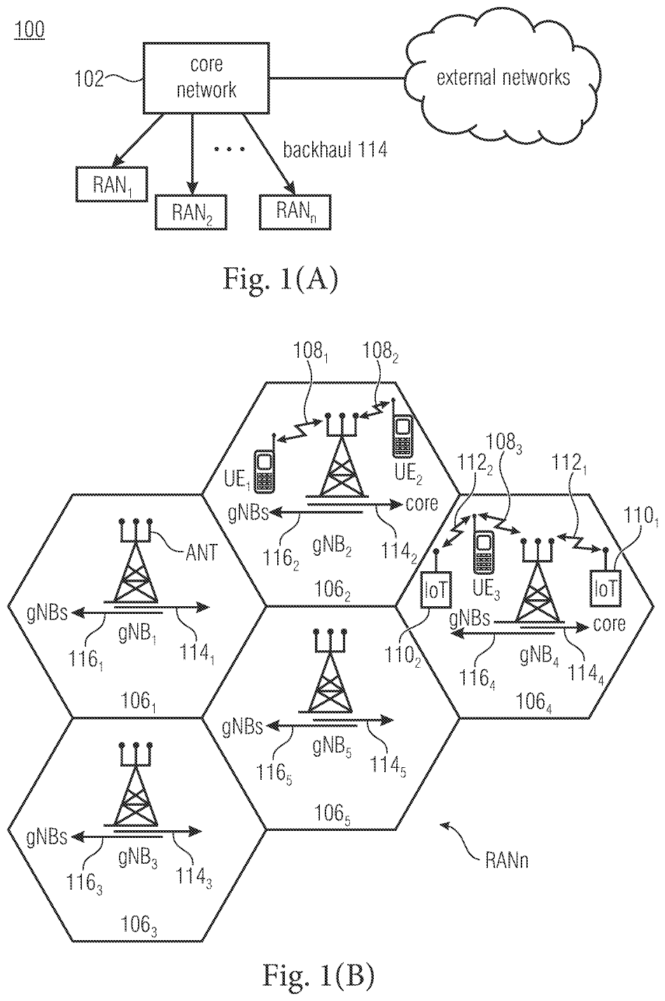

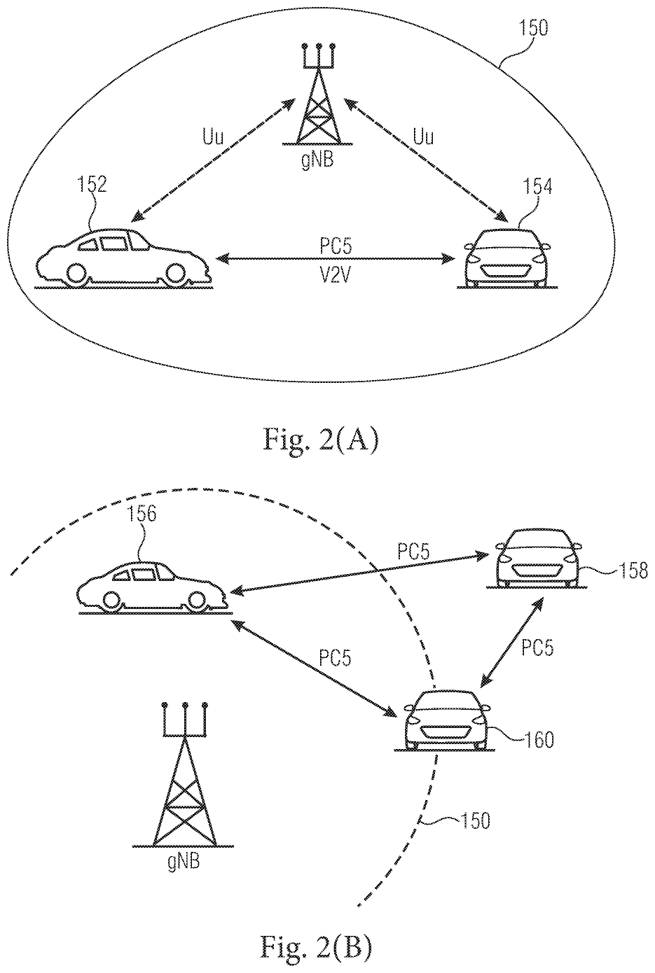

In a wireless communication system or network, like the one described above with reference to FIG. 1(A) or 1(B) or with reference to FIG. 2(A) or 2(B), for improving the communication among entities within the wireless communication network, so-called assistance information may be provided. For example, when considering transmissions over a sidelink among user devices of the wireless communication network, improvements in the reliability and the latency of transmissions, like transmissions occurring in vehicular communications or in public safety and commercial use cases, may be achieved by providing for an inter-UE coordination. The inter-UE coordination may provide assistance by a first UE to a second UE, for example, in the form of a set of resources determined by the first UE to be available or non-available for use by the second UE. Such a report, also referred to as assistance information message, may be send to the second UE, which, in turn, may use the report to decide the transmission resources to be used for a transmission by the second UE. The report or assistance information may be included in one or more assistance information messages, AIMs, which may be transmitted using, for example, a 2^{nd}stage SCI carrying all of the AIMs or pointing to resources in the PSSCH that carry the AIM.

An AIM may also include other information for supporting an operation of a UE over the sidelink. For example, for the operation over the SL, the UE may obtain, in addition to the resource allocation information or instead of the resource allocation information, one or more of link related assistance information, distance related assistance information, geographical area related assistance information, group related assistance information, relay related assistance information.

For example, with regard to the link quality information, the AIM may provide the UE with one or more of:
a report including quality information about a link between two or more of the SL UEs, e.g., channel quality information or channel state information (CSI) or information on interference, or
beamforming information, e.g., a Sounding Reference Signal, SRS, or a SRS Resource Indicator, SRI,
one or more transmission power thresholds, e.g., information to restrict the transmit power of a UE in order to reduce the interference on links between further UEs or information on increasing the transmit power if there are only a few UEs in the scenario and the current interference is below a certain threshold to increase the coverage among the current UEs.

For example, with regard to the distance related assistance information, the AIM may provide the UE with one or more of:
a minimum required communication range for a communication between two or more SL UEs, e.g., to determine whether a SL UE is to send a Hybrid Automatic Repeat Request, HARQ, feedback or not, or
a physical distance between two or more SL UEs, e.g., to determine the transmission power to be used,
a zone ID or a list of zone IDs, relating to the geographical position of one further UE and/or other further UEs, e.g., to be used to optimize transmission power or feedback procedures, e.g., HARQ, or to select links for communication.

For example, with regard to the geographical area related assistance information, the AIM may provide the UE with one or more of:
geographical information, e.g., GPS coordinates, or
path tracking information, e.g., to inform the further UEs about the direction and speed of the UE, or
route information, e.g., to inform the further UEs about the potential exit of the UE from a platoon,
a zone ID or a list of zone IDs, relating to the geographical position of one further UE and/or other further UEs, e.g., to be used to optimize transmission power or feedback procedures, e.g., HARQ, or to select links for communication.

For example, with regard to the group related assistance information, the AIM may provide the UE with one or more of:
an identification of the group, e.g., a group ID, or
an identification of a group leader, e.g., a group leader ID, or
an identification of one or more group members, e.g., a group member ID, or
configuration information, e.g., resource pool information indicating resources to be used for a communication within the group, or
transmission related information, e.g., transmission parameters to be used for group communication, e.g., modulation and coding scheme, MCS, transmit power, timing advance, TA, HARQ operation,
a list of group members, or
trajectory information of the group members, e.g., to determine a possibility of a UE leaving the group, or
a distance between member UEs or other distance-related information, like a vector with zone IDs, e.g., to determine whether to send HARQ feedback or not, or
resources to be used for transmission within the resource pool, or
information regarding an addition or a removal of one or more member UEs to or from the group.

For example, with regard to the relay related assistance information, the AIM may provide the UE with one or more of:
one or more relay UEs, or
a capacity of one or more relay UEs, or
a transmission mode of one or more relay UEs, or
an identification of one or more relay UEs, like a relay UE ID, or
a selected relay UE, or
one or more candidate relay UEs, or
a capacity of a set of one or more candidate relay UEs, or
a transmission mode of one or more candidate relay UEs, or
a distance and/or path information of one or more candidate relay UEs.

The report or assistance information is also described, for example, in European patent application EP 20164706.2 “NR sidelink assistance information messages” filed on Mar. 20, 2020, the content of which is incorporated herewith by reference, in European patent application EP 20197035.7 “Timing aspects for NR SL assistance information messages” filed on Sep. 18, 2020, the content of which is incorporated herewith by reference, and in European patent application EP 20199880.4 “NR sidelink multi-control/data multiplexing” filed on Oct. 2, 2020, the content of which is incorporated herewith by reference. Timing aspects regarding the transmission of AIMs are described, for example, in European patent application 20197035.7 “Timing aspects for NR SL assistance information messages” filed on Sep. 18, 2020, the contents of which is incorporated herewith my reference.

The above-mentioned inter-UE coordination includes the assistance information that is provided by a first UE, like UE-A, to a second UE, UE-B, so that UE-B may carry out a resource selection for performing a transmission from UE-B to another UE, the UE being either UE-A providing the assistance information or any other UE in the vicinity of UE-B. For example, in NR V2X a Mode 2 UE is expected to carry out the resource allocation autonomously, i.e., such a UE does not receive any assistance from the gNB in the form of dynamic or configured grants nor from any other source. Such a UE carries out sensing in order to determine available resources that it may use for its own transmission. The sensing process for determining resources to be used for the transmission may be supported by the inter-UE coordination, for example by providing the assistance information. The sensing process and how the assistance information may support this sensing process is now described.

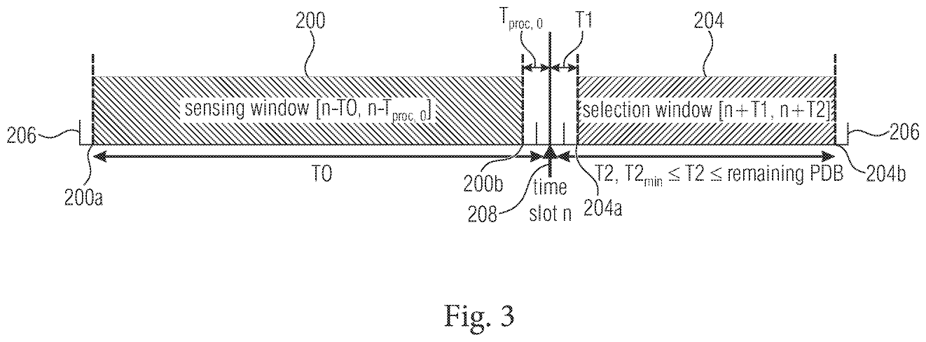

FIG. 3 illustrates a sensing process that may be performed by a UE for autonomously selecting resources. FIG. 3 illustrates a sensing window 200 with its the start 200a and its end 200b, as well as a selection window 204 with its the start 204a and its end 204b. A plurality of time slots 206 are illustrated, and it may be seen that the sensing window 200 as well as the selection window 204 spans a certain number of time slots 206. FIG. 3 further illustrates at 208 the time slot n, which is the time slot at which a transmission to be performed by the UE is triggered. Note that the UE does not necessarily has to perform sensing during the whole sensing window, but may be configured to only perform partial sensing using sub-intervals, periodic or aperiodic, within the sensing window. The reason for this might be that the UE has to perform power saving and may rely on a subset of sensing results.

For example, the trigger may be that the UE determines that a buffer includes data or a data packet to be transmitted, so that responsive to this determination or trigger, at the time slot n, the UE selects resources to be used for the transmission of the data or packet in the transmit buffer. The selection is based on resource information obtained during the sensing window 200. In accordance with other examples, the transmission of data at time slot n may be triggered by the following events:
from a Medium Access Control, MAC, layer perspective, when a protocol data unit, PDU, is generated by the MAC layer and is made available to the physical, PHY, layer,
from an application layer perspective, when an event, ranging from the availability of sensor information to be shared to an untoward incident, like an accident, generates data that needs to be transmitted.

The process of sensing is where a Mode 2 UE takes into account, for example, first stage SCIs received from other UEs so as to identify resources that have been reserved by these other UEs in the recent past. The UE also measures the sidelink, SL, RSRP in the time slots defining the sensing window 200 so as to determine interference levels if the UE were to transmit using these resources. This enables the UE to identify resources which are available for the transmission as well as resources that are not available for the transmission. When the UE intends to carry out the transmission, for example responsive to the trigger event at time slot n, the process of resource selection is triggered where the UE considers the sensing results over a time period in the past, prior to the triggering of the transmission or the resource selection. The just-mentioned time period in the past is the sensing window 200 which is the time period within which the UE considers the sensing results in order to determine possible resources for the transmission. As is illustrated in FIG. 3, the sensing window 200 commences a certain time 200a in the past with reference to the time slot n at which the transmission is triggered. The time period from the time slot n at which the sensing window 200 commences is the time T₀ that has a certain configured or preconfigured length of, for example, 1100 ms or only 100 ms. The sensing window 200, in the example of FIG. 3, concludes 200b shortly before the selection process or transmission is triggered at time slot n. The time period between the end of the sensing window 200 and the time slot n is indicated in FIG. 3 as T_{proc,0}. In accordance with other examples, the sensing window may conclude immediately at the time slot n so that T_{proc,0}=0. Thus, the duration of the sensing window may be defined by [n−T0, n-T_{proc,0}].

T₀ may be defined by higher layers, for example by a resource pool, RP, configuration using the parameter sL-SensingWindow-r16. T0 may be between 100 ms and 1100 ms. T_{proc,0} may be defined as indicated in the following table, dependent on the subcarrier spacing used in the resource pool.

| μ_{SL} | T_{proc, 0} [slots] |
|---|---|
| 0 | 1 |
| 1 | 1 |
| 2 | 2 |
| 3 | 4 |

The results generated by the sensing process are called sensing results. The sensing results indicate for a set of time and frequency resources whether certain resources are available and/or unavailable for a transmission. The indicated resources may be within a specific resource pool, like a sidelink resource pool of the wireless communication system, and are spread over a specific duration of time in the past, namely the sensing window 200. The sidelink resource pool may be a transmit resource pool, a receive resource pool, an exceptional resource pool, a resource pool used for Mode 1 or a resource pool used for Mode 2.

On the basis of the information obtained by the sensing process, the UE, for the transmission triggered at time slot n, selects resources within the selection window 204. As it is depicted in FIG. 3, the selection window begins 204a shortly after the transmission or resource selection trigger, for example at a time period T1 following time slot n. In other examples, the selection window 204 may start immediately at time slot n so that T1=0. The end 204b of the selection window is the time T2 that is determined, for example by the packet delay budget, PDB, associated with the data or packet that is to be transmitted by the UE. The selection window 204 is the time period within which the UE selects resources by taking into account the sensing information, extrapolating the available resources based on the sensing information to generate a candidate resource set, and selecting resources randomly from within the candidate resource set for the transmission triggered.

The duration of the selection window 204 may be defined by [n+T1, n+T2], where T1 and T2 may be defined in accordance with the UE implementation. T1 may as follows: 0<T1<T_{proc,1}, where T_{proc,1} may be defined as shown in the following table with reference to the subcarrier spacing used for the resource pool from the which the resources for the transmission are selected.

| μ_{SL} | T_{proc, 1} [slots] |
|---|---|
| 0 | 3 |
| 1 | 5 |
| 2 | 9 |
| 3 | 17 |

T2 may be defined based on the packet delay budget, PDB, and T2ₘᵢₙ, which may be defined by higher layers, for example, using a resource pool, RP, configuration, by the parameter SL-SelectionWindow-r16, may take a value between 1, 5, 10 and 20 milliseconds, dependent on a priority of the data or packet to be transmitted by the UE. For example, in case T2<remaining PDB, the following holds:
if T2<remaining PDB, T2ₘᵢₙ≤T2≤remaining PDB
else, T2=remaining PDB

With the sensing and selection windows defined, the UE autonomously selects resources as follows. All resources within the selection window 204 are initially considered candidate resources that may be used by the UE for a transmission. Hence, the UE gathers all the resources within the one or more time slots and the one or more sub-channels to form a candidate resource set S_{A} and the size of the candidate resource set S_{A}, based on the number of resources within the set, is given by Mₜₒₜₐₗ. The UE then proceeds to exclude certain resources from the candidate resource set until it arrives at a final candidate resource set, referred to as S_{B}. The number of resources in the final candidate resource set S_{B} may be less than the number of resources Mₜₒₜₐₗ in the original candidate resource set S_{A}.

The resources may be excluded in case a certain condition exists. For example, when the UE is transmitting another transmission at a given time slot so that it has not received anything due to half-duplex constraint, resources from the given such time slot are excluded from the initial candidate resource set S_{A}. In case any received SCI indicates a resource reservation period, the UE excludes any future resources indicated by the reservation period from the initial candidate resource set S_{A}. When an RSRP measurement on a certain resource is higher than a threshold, like a SL-RSRP threshold, that may be set using a priority value received in an SCI and a priority value associated with the triggered invention, the UE excludes such a resource from the initial candidate resource set S_{A}. Resources that are indicated in the received SCI and are extrapolated for future periodic transmissions may also be excluded.

In case the final candidate resource set SB is less than a certain percentage of the total number of resources available in the selection window, it is determined that there are not sufficient resources from which the UE may select those for performing the triggered transmission. In such a case, the UE reduces the SL-RSRP threshold and repeats the selection process on the basis of any one of the above conditions. The just-mentioned percentage may be referred to by X, and the size of the final candidate set is not to be less than X·Mₜₒₜₐₗ. Once the final candidate resource set SB is decided by the UE, the UE sends this final candidate resource set SB to the higher layers which randomly, e.g. based on a uniform distribution, selects a required number of resources from the final candidate resource set SB, and those selected resources are then used by the UE for the triggered transmission. For supporting the above-described process, assistance information messages may be provided to the UE that carries out the sensing process. The UE may receive one or more AIMs, and some or all of the AIMs may contain information for assisting the UE in its resource selection process. The AIMs may indicate available/non-available resources for a transmission, for example, in one or more of the following ways:
by a list of all resources that are available in one or more time slots,
by a list of all resources that are unavailable in one or more time slots,
by a list of resources for which collisions are expected, e.g., a list of reserved resources where the further UE is expected to transmit as well,
by one or more randomly selected resources that are available in one or more time slots,
by a list of resources that are unavailable/reserved within a priority range.

A resource comprises
a set of time slots across time and a set of subchannels across frequency, or
one or more resource blocks, RBs, across a time slot in time and across a sub channel in frequency.

For example, the AIM indicates the resources across time in any one of the following manners:
by a bitmap across time, the bitmap indicating resources, like OFDM symbols or time slots or subframes or frames, where the resource set is defined, spanning either a portion or the entire length of the one BWP,
by a starting resource, like a time slot or a subframe, and a duration of the resource set,
by explicit resources numbers, like time slot or subframe numbers,
by puncturing out resources mentioned explicitly or that are part of another set of resources or RP,
by a starting resource, and periodic offsets for subsequent occurrences,
by a pattern of symbols, time slots or subframes or frames,
by a formula used to define the time resource indicator value, TRIV defined in TS38.214 as follows:

```
if N = 1
      TRIV = 0
    elseif N = 2
      TRIV = t₁
    else
      if (t₂ − t₁ − 1) ≤ 15
        TRIV = 30 (t₂ − t₁ − 1) + t₁ + 31
      else
        TRIV = 30 (31 − t₂ + t₁) + 62 − t₁
      end if
  end if
```

where,
N indicates the number of time slots indicated by the AIM, where
   0 means the time slot where the AIM was received,
   1 means the time slot where the AIM was received as well as one more future time slot with respect to the time slot the AIM was received,
   2 means the time slot where the AIM was received as well as two more future time slots with respect to the time slot the AIM was received,
t₁ indicates the first future resource time slot with respect to the time slot the AIM was received, and
t₂ indicates the second future resource time slot with respect to the time slot the AIM was received.

The AIM may indicate the resources across frequency in any one of the following manners:
by a bitmap, the bitmap the bitmap indicating resources, like resource blocks, across the one BWP,
by a starting resource, like a resource block, and a number of resources for a resource set,
by multiple starting resources, like resource blocks, and ending resources, if the resource set is non-contiguous over frequency,
by explicit resource indices, like resource block indices,
by puncturing out resources mentioned explicitly or that are part of another set of resources or RP,
by a starting resource, and periodic offsets for subsequent occurrences,
by a pattern of resource blocks or subchannels,
by a formula used to define the frequency resource indicator value, FRIV, defined in TS38.214 as follows:

FRIV=i_{subCH,1}^{start}+Σᵢ₌₁^{L}^{_{subCH−1}}(N_{subchannel}^{SL}+1−i).

The AIM may indicate the resources across time and frequency in any one of the following manners:
by a matrix, the matrix indicating the resources across time, like symbols, time slots or subframes or frames, and across frequency, like resource blocks or subchannels,
by a pattern, the pattern indicating the resources across time, like symbols, time slots or subframes or frames, and across frequency, like resource blocks or subchannels.

The pattern may be signaled as a bitmap or bit vector.

The resources contained within the AIM may be interpreted by a UE as one of three different types of resources:
Sensing results
   The sensing results include a plurality of resources within a sensing window of the UE sending the AIM and/or measured power levels, like a measured Reference Signal Received Power, RSRP, a measured Received Signal Strength Indicator, RSSI, a measured Reference Signal Received Quality, RSRQ, a measured Signal to Noise Ratio, SNR, or a measured Signal and Interference to Noise Ratio, SINR, associated with the respective resources.
Candidate resource set
   The candidate resource set includes a set of available/preferred or unavailable/not preferred resources within a selection window of the UE sending the AIM.
Specific resources
   The one or more specific resources include one or more resources to be used for a transmission by the UE. The one or more resources may be selected from a candidate resource set obtained by the UE sending the AIM. The candidate resource set obtained by the UE sending the AIM may include resources that were reserved by the UE providing the AIM, but remained unused. For example, this may be the case when the further UE providing the AIM had reserved resources for retransmissions, e.g., within a window size of 32 time slots, that remained unused due to an early ACK, or when during periodic transmissions a packet did not arrive in time or the transmission was paused.

The present invention provides improvements and enhancements regarding the use of the above-described AIMs including resource information at the UE receiving the AIM. More specifically, in accordance with the present invention, a UE receiving one or more AIMs including resource allocation related assistance information may decide how to use the received AIM for obtaining resources for its transmission dependent on the type of resource allocation related assistance information contained in the received AIM and/or dependent on a certain criterion. In other words, the actions taken by the UE receiving an AIM may be decided on the basis of the content of the AIM. As mentioned above, the AIM may include sensing results as well as a set of resources. The set of resources may indicate available or preferred resources to be used by the UE or unavailable or not preferred resources that are to be avoided by the UE. The set of resources may indicate a candidate resource set to be used by the UE in the above-described sensing process, or it may include a specific set of resources that is to be used by the UE for its own triggered transmission. Apart from the content of the AIM, also other criteria may be considered by the UE to decide whether a received AIM is to be used or not. Moreover, in accordance with embodiments, the inventive approach also addresses the situation of a UE receiving two or more AIMs and the question which of the received AIMs is to be considered and which is not, or whether all or none of the AIMs are to be considered.

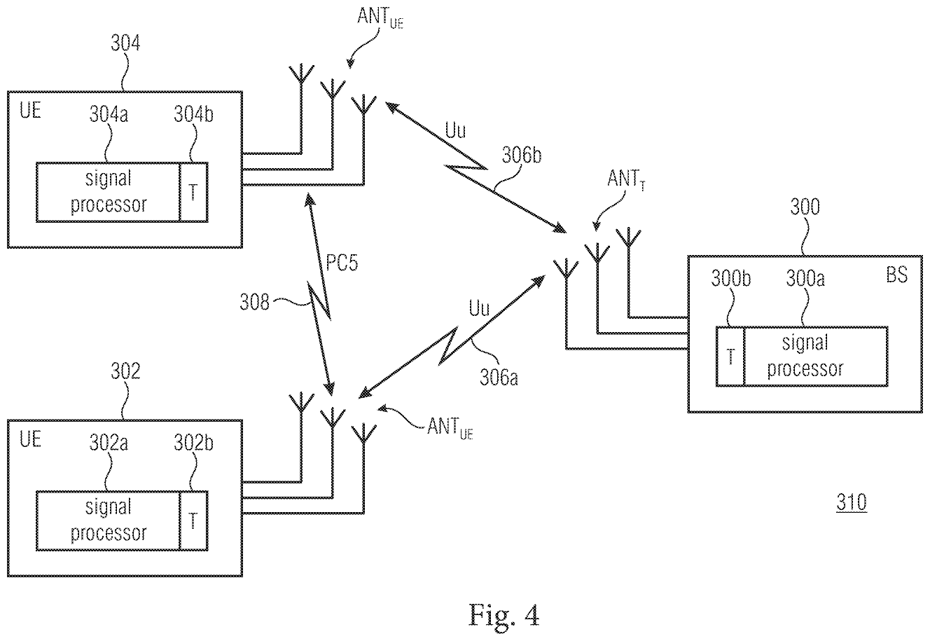

Embodiments of the present invention may be implemented in a wireless communication system as depicted in FIG. 1(A) and 1(B) including base stations and users, like mobile terminals or IoT devices. FIG. 4 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link.

The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink, SL, interface. When the UEs are not served by the base station or are not connected to a base station, for example, they are not in an RRC connected state, or, more generally, when no SL resource allocation configuration or assistance is provided by a base station, the UEs may communicate with each other over the sidelink, SL. The system or network of FIG. 4, the one or more UEs 302, 304 of FIG. 4, and the base station 300 of FIG. 4 may operate in accordance with the inventive teachings described herein.

### User Device Receiving an AIM

The present invention provides a user device, UE, for a wireless communication network, the wireless communication network including a plurality of user devices, UEs,
wherein the UE is to communicate with one or more network entities of the wireless communication network, like a base station or another UE,
wherein, responsive to a trigger for a transmission, the UE is to obtain resources for the transmission
wherein the UE is to receive from one or more further UEs one or more reports or assistance information messages, AIMs, the report or AIM including resource allocation related assistance information, and
wherein, dependent on a type of resource allocation related assistance information contained in the received report or AIM and/or dependent on a certain criterium, the UE is to decide how to use the received report or AIM for obtaining resources for the transmission.

In accordance with embodiments, the type of resource allocation related assistance information includes one or more of
sensing results, the sensing results comprising a plurality of resources within a sensing window of the further UE and measured power levels, e.g., the measured Reference Signal Received Power, RSRP, associated with the respective resources,
a candidate resource set, the candidate resource set comprising a set of available/preferred or unavailable/not preferred resources within a selection window of the further UE,
one or more specific resources, the one or more specific resources comprising one or more resources to be used for a transmission by the UE, wherein
   the one or more resources are selected from a candidate resource set obtained by the further UE, and/or
   the one or more resources are reserved by the further UE, but remain unused.

### Sensing Results

In accordance with embodiments, when the type of resource allocation related assistance information comprises sensing results that are that are valid for the transmission, the UE is to consider some or all of the received sensing results for obtaining resources for the transmission.

In accordance with embodiments, the sensing results are valid for the transmission when one or more of the following applies:
the sensing results are within a sensing window of the UE, the sensing results are not older than a certain timestamp, e.g. where the timestamp is compared to the time the AIM was received by the UE,
the start or end of the sensing window used by the further UE to generate the sensing results, are not older than a configured or pre-configured time instance,
the sensing results are obtained within a certain distance from the UE or within a certain geo-location or region,
an origin of the sensing results is a particular network entity, e.g. a further UE with a certain ID, a GL-UE, an RSU,
the sensing results are confirmed by another sensing result.

In accordance with embodiments, the received sensing results include one or more of the following:
power levels, like Reference Signal Received Power, RSRP, values, of the resources measured by the further UE when carrying out sensing, or
an indication whether the resources obtained by the further UE when carrying out sensing are occupied or unoccupied, e.g., based on a comparison between a threshold, like a RSRP threshold, and a power level, like an RSRP values measured by the further UE in the given resource, or
a list of unoccupied resources, like resources having a power level, like an RSRP, value measured by the further UE below a threshold, like a RSRP threshold, or
a list of occupied resources, like resources having a power level, like an RSRP value, measured by the further UE above a threshold, like an RSRP threshold.

In accordance with embodiments, the UE is to consider only some of the received sensing results for obtaining resources for the transmission, for example
a predefined number of resources having the least measured power level, or
the first m or top-m resources indicated in the AIM, with m being an integer, or
resources indicated by a certain UE, e.g., based on an ID or a capability or a type of the UE.

In accordance with embodiments, the UE is to obtain own sensing results during a sensing window preceding the trigger, and when one or more of the own sensing results concern resources indicated in the received sensing results, the UE is to carry out one of the following actions;
ignore the received sensing results and consider only the own sensing results,
ignore the own sensing results and consider only the received sensing results,
merge the own sensing results and the received sensing results, e.g., by:
   taking an average or minimum or maximum of the power levels measured on a resource by UE and by the further UE,
   weighting the received sensing results with a probability, thereby making them less or more relevant than the own sensing results.

In accordance with embodiments, in case the UE has no own sensing results during a sensing window preceding the trigger, the UE is to consider all of the received sensing results for obtaining resources for the transmission.

In accordance with embodiments, the UE is to provide a received AIM from the MAC layer to the PHY layer for comparing the sensing results measured by the UE on the PHY layer and the sensing results in the AIM.

### Preferred Set of Resources, e.g., a Candidate Resource Set or Specific Resources

In accordance with embodiments, when the type of resource allocation related assistance information comprises a set of available or preferred resources within a selection window of the further UE, the UE is to use some or all of the resources from the received set of available or preferred resources.

In accordance with embodiments,
responsive to the trigger, the UE is to perform a resource selection process to obtain an own candidate resource set for the transmission, and
when the set of available or preferred resources comprises a candidate resource set, the UE is to add to the own candidate resource set some or all resources that are indicated in the received candidate resource set and that are within a selection window of the UE.

In accordance with embodiments, the UE is to form a combined candidate resource set to be used for the resource selection for the transmission, the combined candidate resource set being obtained by selectively combining resources from the own candidate resource set and from the received candidate resource set.

In accordance with embodiments, the UE is to combine the resources from the own candidate resource set and from the received candidate resource set as follows:
if a resource is indicated in both of the own and received candidate resource sets, the UE is to include the resource to the combined candidate resource set, and
if a resource is indicated in only one of the own and received candidate resource sets, the UE is not to include the resource to the combined candidate resource set.

In accordance with embodiments, the UE is to combine the resources from the own candidate resource set and from the received candidate resource set as follows:
if a resource is indicated in both of the own and received candidate resource sets, the UE is to include the resource to the combined candidate resource set,
if a resource is indicated in the own candidate resource set but not in the received candidate resource set, the UE is to not include the resource into the combined candidate resource set, and
if a resource is indicated in the received candidate resource set but not in the own candidate resource set, the UE is to include the resource into the combined candidate resource set.

In accordance with embodiments, the UE is to combine the resources from the own candidate resource set and from the received candidate resource set as follows:
if a resource is indicated in both of the own and received candidate resource sets, the UE is to include the resource to the combined candidate resource set,
if a resource is indicated in the own candidate resource set but not in the received candidate resource set, the UE is to include the resource into the combined candidate resource set, and
if a resource is indicated in the received candidate resource set but not in the own candidate resource set, the UE is to not include the resource into the combined candidate resource set.

In accordance with embodiments, if a resource is indicated in the received candidate resource set but not in the own candidate resource set, the UE is to include the resource into the combined candidate resource set when a distance between the UE and the further UE is below a threshold, or when a timing associated with the received candidate resource set is below a threshold.

In accordance with embodiments, in case a number of resources in the combined candidate resource set is below a predefined threshold, the UE is to
generate a new own candidate resource set using a new, higher power level threshold, like a higher RSRP value, and
obtain a new combined candidate resource set by combining resources from the new own candidate resource set and from the received candidate resource set.

In accordance with embodiments, the UE is to combine the resources from the own candidate resource set and from the received candidate resource set by including resources into the combined candidate resource set that are common to both of the own and received candidate resource sets.

In accordance with embodiments, in case a number of common resources is below a predefined threshold, the UE is to consider other resources from either the own candidate resource set or from the received candidate resource set.

In accordance with embodiments, the UE is to consider other resources from the received candidate resource set, when a distance between the UE and the further UE or a timing associated with the received candidate resource set is below a threshold.

In accordance with embodiments, in case the UE does not perform a resource selection process, or in case the UE does perform only partial sensing and/or does not have sensing results pertaining to the selection window, responsive to the trigger and when the set of available or preferred resources comprises a candidate resource set, the UE is to provide the received candidate resource set for a selection of resources for the transmission.

In accordance with embodiments, the set of available or preferred resources comprises a set of specific resources, the UE is to use the received set of specific resources for a selection of resources to be used for the transmission, regardless of whether the UE performs a resource selection process to obtain an own candidate resource set for the transmission or not, the set of specific resources comprising one or more resources selected from a candidate resource set obtained by the further UE and to be used for the transmission by the UE.

Not preferred set of resources, e.g., a candidate resource set or specific resources) In accordance with embodiments, when the type of resource allocation related assistance information comprises a set of unavailable or not preferred resources within a selection window of the further UE, the UE is not to use the resources from the received a set of unavailable or not preferred resources.

In accordance with embodiments,
responsive to the trigger, the UE is to perform a resource selection process to obtain an own candidate resource set for the transmission, and
when the set of unavailable or not preferred resources comprises a candidate resource set, the UE is to exclude from the own candidate resource set some or all of the resources that are also indicated in the received candidate resource set.

In accordance with embodiments, the UE is to exclude a certain number of resources from the received candidate resource set, like m resources, e.g., the m worst resources or randomly any m resources, or any contiguous set of m resources, m being an integer.

In accordance with embodiments, in case a number of resources in the own candidate resource set is below a predefined threshold after excluding resources that are also indicated in the received candidate resource set, the UE is to
generate a new own candidate resource using a new, higher power level threshold, like a higher RSRP value, and
exclude from the new own candidate resource set any resources that are also indicated in the received candidate resource set.

In accordance with embodiments,
responsive to the trigger, the UE is to perform a resource selection process to obtain a candidate resource set for the transmission,
when the set of unavailable or not preferred resources comprises a set of specific resources, the UE is to exclude from the candidate resource set the received set of specific resources, the set of specific resources comprising one or more resources selected from a candidate resource set obtained by the further UE and not to be used for the transmission by the UE.

In accordance with embodiments, in case a number of resources is below a predefined threshold after excluding the received set of specific resources, the UE is to
(a) request, e.g., higher layers, to select additional resources for the transmission randomly from one or more previously received AIMs, like a previous candidate resource set, and to add the selected resources to the candidate resource set, thereby obtaining a new candidate resource set,
(b) exclude from the new candidate resource set the set of specific resources,
(c) repeat steps (a) and (b) until the new candidate resource set does not include any of the specific resources.

In accordance with embodiments,
responsive to the trigger, the UE is to perform a resource selection process to obtain a final set of resources to be used for the transmission,
after obtaining the final set of resources, the UE is to receive the set of unavailable or not preferred resources AIM, and
the UE is to exclude from final set of resources the received set of specific resources.

In accordance with embodiments, in case a number of resources in the final set of resources is below a predefined threshold after excluding the received set of specific resources, the UE is to:
(a) repeat the resource selection process to obtain a new final set of resources,
(b) exclude from the new final set of resources the received set of specific resources,
(c) repeat steps (a) and (b) until the new candidate resource set does not include any of the specific resources.

In accordance with embodiments, the UE is to maintain a received AIM at the MAC layer and to handle the received AIM at the MAC layer.

In accordance with embodiments, a selection weight is factored in to each of the resources within the AIM depending on one or more of:
a source of the AIM,
a received power of the AIM,
a location and/or a distance and/or a speed of the further UE that sent the AIM,
a timestamp or age of the AIM.

In accordance with embodiments, the selection weight of certain resources is modified when factoring in the AIM by one or more of:
decreasing the selection probability if a resource is not within the set,
increasing the selection probability if a resource is within the set,
decreasing the selection probability if a resource is within the set,
increasing the selection probability if a resource is not within the set.
decreasing the selection probability if a resource is within a non-preferred set.

In accordance with embodiments, the resources received from the AIM are considered only if the selection weight is one or more of the following:
above a configured or pre-configured threshold,
a part of the top-m probabilities.

### Other Criteria

In accordance with embodiments, the certain criterium comprises one or more of the following:
an intended receiver of the triggered transmission,
priority or power level threshold associated with the report or AIM,
a type or capability of the further UE sending the report or AIM,
a location or zone of the further UE sending the AIM,
a distance of the further UE sending the AIM,
a region within which the further UE sending the AIM is situated in,
a cast type attached to the AIM.

In accordance with embodiments, in case the intended receiver of the triggered transmission is the further UE sending the AIM, the UE is
to use the resources indicated in the AIM only for the transmission to the further UE, in the case that the AIM contains a set of preferred resources, or
not to use the resources indicated in the AIM for the transmission to the further UE, in the case that the AIM contains a set of not preferred resources.

In accordance with embodiments, in case the intended receiver of the triggered transmission is another UE not sending the AIM, the UE is
to use the resources indicated in the AIM for the transmission to the other UE, in the case that the AIM contains a set of preferred resources, or
not to use the resources indicated in the AIM for the transmission to the other UE, in the case that the AIM contains a set of not preferred resources.

In accordance with embodiments, in case the AIM includes a set of not preferred resources and a priority is associated with the resources, the UE is to exclude the resources indicated in the AIM, if the triggered transmission is of a priority lower than the priority associated with the resources indicated in the AIM.

In accordance with embodiments, in case pre-emption is enabled, e.g., in a resource pool, the UE is to use the resources indicated in the AIM, if the triggered transmission is of a priority equal to or higher than the priority associated with the resources indicated in the AIM,

In accordance with embodiments, in case the AIM incudes a set of not preferred resources and a power level threshold, like an RSRP value, used by the further UE to generate the AIM, the UE is to compare the power level threshold associated with the AIM against the power level threshold of the triggered transmission, and to exclude the resources indicated in the AIM, if the power level threshold associated with the AIM is lower than the power lever threshold of the triggered transmission.

In accordance with embodiments, in case the AIM incudes a set of not preferred resources, the UE to exclude the resources indicated in the AIM, if a priority is associated with the resources of the AIM and/or a power level threshold, like an RSRP value, used by the further UE to generate the AIM is lower than a configured or pre-configured priority or power level threshold, like a priority and/or power level threshold defined for a resource pool or by system wide configuration.

In accordance with embodiments, in case the AIM includes a set of preferred resources and a priority is associated with the resources, the UE is to consider the resources indicated in the AIM, if the triggered transmission is of a priority equal to or higher than the priority associated with the resources indicated in the AIM.

In accordance with embodiments, in case the AIM incudes a set of preferred resources and indicates a priority associated with the resources and/or a power level threshold, like an RSRP value, used by the further UE to generate the AIM, and a pre-emption is enabled, e.g., in a resource pool, the UE is to consider the AIM regardless of the priority and/or power level threshold.

In accordance with embodiments, in case the AIM indicates a type of the further UE sending the AIM or the UE is capable to identify the type of the further UE sending the AIM, the UE is to consider AIMs received from a plurality of further UEs in accordance with a defined hierarchy so that when receiving two or more AIMs from different further UEs, the UE is to consider the AIM from the further UE being highest in the hierarchy.

In accordance with embodiments, the defined hierarchy comprises a priority associated with certain types of further UEs, e.g., any further UE that receives information from a base station, like a gNB, or from a core network entity, has a priority higher than another further UE.

In accordance with embodiments, in case the AIM includes a parameter that indicates a location of the further UE sending the AIM or a region within which the further UE sending the AIM is located, the UE is to determine a distance between the UE and the further UE or between the UE and the region, and, using the distance information, the UE is to consider an AIM from further UE when the distance is below a threshold, e.g., when the further UE is located within a configured or pre-configured minimum distance from the UE or within a configured or pre-configured region.

In accordance with embodiments, in case the UE does not perform a resource selection process responsive to the trigger, the UE is to rely on the one or more AIMs for obtaining resources for the transmission, if the one or more AIMs are provided by one or more further UEs located within a predefined distance from the UE or within a predefined region, e.g., within a validity distance around the UE or within a validity area defined at a system level, a resource pool level, a source level or a transmission level.

In accordance with embodiments, in case the AIM includes a cast type, the UE is to weight the AIM according to the cast type, e.g., such that
an unicasted AIM, like an AIM meant exclusively for the UE alone, is weighted higher than a groupcasted AIM, like an AIM meant exclusively for a certain group of UEs, and higher than a broadcasted AIM, like an AIM meant for any UE receiving the AIM, or
a groupcasted AIM, like an AIM meant exclusively for a certain group of UEs, is weighted higher than an unicasted AIM, like an AIM meant exclusively for the UE alone, and higher than a broadcasted AIM, like an AIM meant for any UE receiving the AIM.

In accordance with embodiments, the UE is to forward an AIM to another UE in the vicinity of the UE,

In accordance with embodiments, the UE is to forward an AIM by duplicating or sending a redundancy version of the AIM.

In accordance with embodiments, the UE is to forward the AIM and to change the cast type as follows:
from unicast to groupcast, or
from unicast to broadcast, or
from groupcast to unicast, or
from groupcast to broadcast, or
from broadcast to unicast, or
from broadcast to groupcast.

In accordance with embodiments, the AIM contains a hop count or a validity timer defining whether the AIM is to be forwarded or not.

In accordance with embodiments, the UE is to receive multiple versions of an AIM and to combine multiple versions in order to increase reliability of reception of an AIM.

In accordance with embodiments, in the case the UE receives a plurality of AIMs from different further UEs for the triggered transmission, the UE is to consider the AIMs based on the following hierarchical conditions:
(1) AIMs that are associated with a priority that is the same as or higher that a priority of the triggered transmission,
(2) AIMs from a further UE which is the intended recipient of the triggered transmission,
(3) AIMs from a further UE that is at a certain distance from the UE, and/or moves into a certain direction with reference to the UE, and/or moves with a certain speed with reference to the UE, and/or is a green-light authority UE.

In accordance with embodiments, in case a number of received AIMs reaches or exceeds a threshold, the UE is to transmit, e.g., as unicast or groupcast or broadcast, a message indicating that no more AIMs of a given type are to be send or that a period of sending AIMs for a certain time is increased.

In accordance with embodiments, a number of AIMs is reduced by:
the UE not considering a certain type of AIMs for a certain time, if a number of AIMs of the certain type received in a time period reaches a limit, wherein the limit may be staggered by limiting different types of AIMs or priorities at different occupancy levels,
the UE is to only consider AIMs in a configured or pre-configured default periodicity and ignore the remaining AIMs.

In accordance with embodiments, the UE is to communicate with
one or more further UEs using a sidelink, SL, interface, like a PC5 interface, and/or
one or more radio access network, RAN, entities of the wireless communication system, like one or more base stations, using a radio interface, like a Uu interface, or using a shared access band, like an unlicensed band.

In accordance with embodiments, the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

### System

The present invention provides a wireless communication system, comprising one or more user devices, UEs, according to the present invention.

In accordance with embodiments, the wireless communication system comprises one or more base stations, wherein the base station comprises one or more of a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a user device, UE, for a wireless communication network, the wireless communication network including a plurality of user devices, UEs, wherein the UE is to communicate with one or more network entities of the wireless communication network, like a base station or another UE, the method comprising:
responsive to a trigger for a transmission, obtaining resources for the transmission
receiving from one or more further UEs one or more reports or assistance information messages, AIMs, the report or AIM including resource allocation related assistance information, and
dependent on a type of resource allocation related assistance information contained in the received report or AIM and/or dependent on a certain criterium, deciding how to use the received report or AIM for obtaining resources for the transmission.

### Computer Program Product

Embodiments of the present invention provide a computer program product comprising instructions which, when the program is executed by a computer, cause the computer to carry out one or more methods in accordance with the present invention.

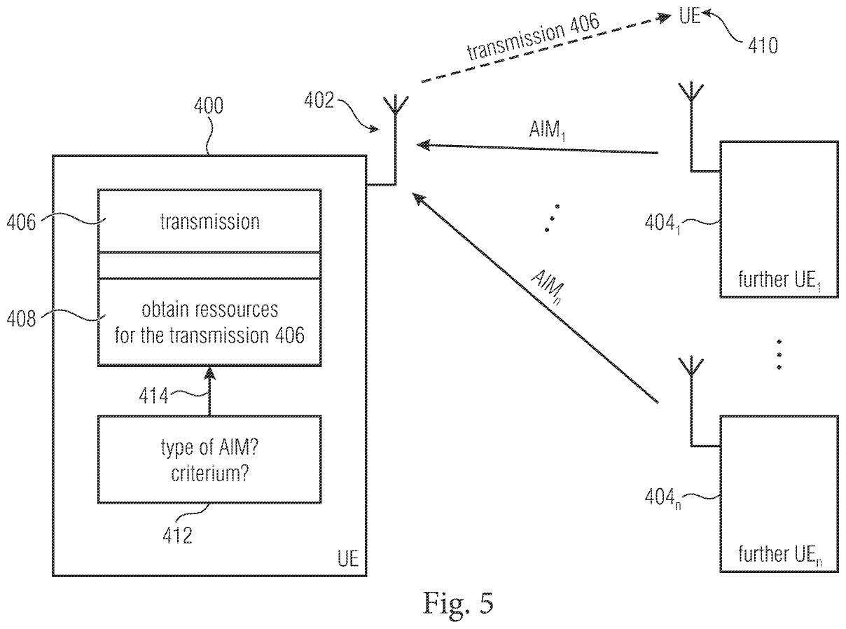

Embodiments of the present invention are now described in more detail, and FIG. 5 schematically represents a user device, UE, in accordance with embodiments of the present invention. FIG. 5 illustrates, schematically, a wireless communication network in which the inventive UE 400 is provided so as to communicate by means of radio signals transmitted via the UE's antenna 402. The network includes, in addition to UE 400, one or more further UEs 404₁ to 404ₙ. Responsive to a transmission 406 to be effected by UE 400, in other words responsive to a trigger for the transmission 406, UE 400 obtains resources for the transmission, as is indicated at 408. The transmission 406 is transmitted by a radio signal via the antenna 402 of UE 400, and the transmission may be directed to one or more of the above-mentioned UEs in the wireless communication network. As is further illustrated in FIG. 5, UE 400 may receive from one or more of the further UEs 404₁ to 404ₙ the assistance information messages AIM₁ to AIMₙ. In accordance with some embodiments, UE 400 may receive only a single AIM from one of the further UEs or it may receive two or more AIMs from either a single further UE or from a plurality of further UEs. The transmission 406 may be directed towards one or more of the further UEs 404 and/or it may be directed another UE not providing an AIM, like any UE in the vicinity or in the communication range of UE 400. When receiving one or more of the AIMs, UE 400, as indicated at 412, determines the type of AIM received, more specifically a type of resource allocation related assistance in the received AIM and/or whether one or more criteria are fulfilled. Dependent on this determination, as is schematically indicated by 414, UE 400 determines how to use the one or more received AIMs for the process 408 for obtaining the resources for the transmission 406.

In the following, further embodiments of the inventive approach are described in more detail explaining how UE 400 decides about the use of a received AIM dependent on the type of resource allocation related assistance information contained in a received AIM and/or dependent on one or more certain criteria.

### AIM Containing Sensing Results

In case the AIM contains sensing results, i.e., for example in case a type of resource allocation related assistance information contained within the AIM or carried by the AIM comprises sensing results, UE 400 uses the measurement and sensing results from the AIM that are available for the respective resources when carrying out the sensing process.

The sensing results received via the AIM may be send from the MAC layer to the PHY layer of the protocol stack of the UE for processing. During the sensing process, the UE performs the measurements on the PHY layer so that the content of the AIM received is to be sent from the MAC layer to the PHY layer for comparing the sensing results.

The UE uses sensing results that are valid for the triggered transmission 406. For example, the sensing results are valid when they are within a sensing window of UE 400, or when they are not older than a certain configured or pre-configured time or time stamp. For example, the time stamp is compared with the time the AIM was received by UE 400, and if it is older, the AIM in not considered valid for the triggered transmission. The AIM is also considered invalid if the start or end of the sensing window used by the further UE 404 is older than a configured or pre-configured time instance. In accordance with other embodiments, sensing results may be considered valid in case they are obtained from a further UE 404 that is located at a certain location or within a certain region, like a certain geo-location, or that is located at a certain distance from UE 400. Also, the sensing results may be considered valid in case their origin is from a particular or predefined network entity, for example, from a further UE having associated therewith a certain identification, ID, or being a group leader UE, GL-UE, or being a roadside unit, RSU, in case of a V2X communication, or the like. The sensing results may also be considered to be valid in case they are confirmed by another sensing result. In accordance with embodiments, any one of the above conditions may be used alone or in combination for considering whether a received AIM is valid or not.

The sensing and measurement results may include the power levels of all the resources that were measured by the further UE 404 when it carried out the sensing process, for example the measured reference signal received power, RSRP, values or sidelink, SL, RSRP values associated with the respective resources. In accordance with other embodiments, the sensing and measurement results may be an indication that certain resources are occupied or unoccupied, for example based on a comparison between the SL-RSRP threshold and the SL-RSRP value measured for a certain resource. In accordance with yet other embodiments, the sensing and measurement results may include a list of only those resources that are not occupied or unoccupied, for example resources for which the SL-RSRP level is measured to be below the SL-RSRP threshold. In accordance with further embodiments, the sensing and measurement results may also include a list of those resources that are occupied, like resources for which a measured SL-RSRP value is above the threshold.

In accordance with embodiments, UE 400 chooses to consider the sensing results for all resources provided in the AIM or only considers those resources with the least measured SL-RSRP values, i.e., a predefined number of resources having the least measured power levels, or a predefined number of the top resources indicated in the AIM, for example, the first m or top-m resources in the AIM, like the first m entries in the above-mentioned list of available or unavailable resources.

In accordance with further embodiments, the UE may consider those resources in an AIM that are associated or indicated by a certain UE, for example on the basis of the sensing window used for the AIM overlapping with the sensing window being used by the UE for its intended transmission. When UE 400 receives the sensing results in the AIM, UE 400 may determine that for at least some of the resources indicated in the AIM, UE 400, due to its sensing process, also has sensing results, i.e., for one or more certain resources sensing results are available from the AIM and from the UE's own sensing process. In accordance with embodiments of the present invention, UE 400 may carry out one of the following actions or procedures for resources for which sensing results are available both from the AIM and from the UE's own sensing process. In accordance with embodiments, UE 400 may ignore the sensing results from the AIM and consider only the UEs own sensing results. For example, the UE may choose this option in case the UE considers the confidence of its own sensing results to be high. For example, this may be the case when UE 400 determines the AIM to be received from a further UE that is far away from UE 400 or in case the sensing and measurement results are older than a certain predefined time stamp. In accordance with other embodiments, UE 400 may ignore the own sensing results and consider only the received sensing results. This option may be used, for example, when the time during which UE 400 was capable to carry out the sensing process was shorter than a predefined threshold, for example because UE 400 operated in the DRX mode, so that only a small number of resources were sensed so that the UE's confidence into the sensing results carried out by UE 400 itself may be low. In such a case, UE 400 may prefer the received sensing results from the AIM over its own sensing results.

In accordance with yet other embodiments, UE 400 may merge or combine the own sensing results and the received sensing results. This option may be taken by the UE, for example, in case UE 400 considers it necessary to increase the confidence of its own sensing results. For example, UE 400 may average the power levels measured on a certain resource by UE 400 and by the further UE 404. In accordance with other embodiments, UE 400 may take the minimum or maximum power level of the two power levels measured for a resource by the UE and the further UE. In accordance with yet other embodiments, the UE may weight or rate the sensing results from the AIM with a certain probability thereby making them more or less relevant than the UE's own sensing results. For example, for weighting the results, the UE may always use its own sensing results, and the sensing results received via the AIM, namely those sensing results received from one or more other or further UEs are only used if they are sufficiently supported, for example only in case a certain resource is reported by at least n UEs to be free, with n being an integer. For example, n may depend on a priority associated with the respective AIMs providing the additional sensing results. In accordance with other embodiments, the measured power levels, like the RSRP values, may be scaled by a certain factor, for example, by 0.9 for the own sensing results and 0.1 for the sensing results from the further UEs provided via the one or more AIMs. The factor may be distributed among the AIMs received from the further UEs so that it sums up to 1 thereby obtaining a weighted average RSRP level on which the thresholding during the selection process may be applied. The factor or the value n may be determined based on one or more of: a priority associated with the AIM, a distance between the UE and the one or more further UEs, a remaining validity time of the AIM, and an age of the information contained in the AIM.

The advantage of merging the sensing results is that UE 400 obtains more confidence about the availability of a certain resource, i.e., the confidence is supported using the additional sensing results obtained from the one or more AIMs.

In accordance with further embodiments, there may be situations in which UE 400 does not have own sensing results for one or more resources from the sensing window, for example due the fact that it was transmitting in that time slot, or because it was operating in DRX mode, or because of a switching from receiving to transmitting or from transmitting to receiving. In such a case, UE 400 only considers the sensing results from the received AIM.

Once UE 400 decided about the sensing results to be used, it generates, as described above, the candidate resource set SA. For example, UE 400 applies the measured RSRP values as reported by the further UE 404 so as to obtain the final candidate resource set SB and proceeds with the resource selection as described above. In other words, in accordance with embodiments of the present invention, the information from the AIM including the sensing results is taken into consideration before UE 400 actually carries out the exclusion process described above, thereby avoiding situations that certain resources are excluded, e.g., because UE 400 was transmitting in a time slot. In accordance with the inventive approach, in such a situation, the information from the AIM is considered before excluding the resources and the basis for the final selection of resources for the actual transmission is broadened, i.e., the confidence into the resources available is increased so that a more reliable transmission in accordance with predefined requirements is associated with the transmission is achieved.

### AIM Containing a Set of Preferred Resources

In case the AIM includes resource allocation related assistance information comprising a set of available or preferred resources within a selection window used by the further UE 404, UE 400 uses some or all of the resources from the received set. When referring to available or preferred resources, this also refers to resources considered to be free or unoccupied, i.e., resources that show a signal level below a certain threshold or an interference level below a certain level.

### AIM Containing a Candidate Resource Set

In case the AIM contains a candidate resource set S_{AIM}, in accordance with embodiments, UE 400 adds the resources that are indicated in the AIM to its own candidate resource set S_{A}. The sensing process performed by UE 400 is not affected by the AIM, i.e., UE 400 generates its own candidate resource set S_{A} independent from the AIM received. In accordance with embodiments, a merged or combined candidate resource set S_{A}+S_{AIM} may be formed by UE 400 by merging or combining resources from the own candidate resource set S_{A} and from the received candidate resource set S_{AIM}.

In accordance with embodiments, UE 400 includes a resource into the combined candidate resource set if the resource is indicated in both of the own and received candidate resource sets. If the candidate resource set S_{AIM} received via the AIM as well as the UE's own candidate resource set S_{A} include a common resource this means that the resource is seen to be vacant by both UE 400 and the further UE 404 meaning that the resource is available for a transmission with a higher probability, so that this resource may be added to the final candidate resource set SB with a higher confidence.

However, in case a resource is indicated in only one of the candidate resource sets, basically, due to this mismatch, UE 400 does not include such a resource into the final candidate resource set S_{B} because it may not be said with a sufficient confidence whether the resource is actually available or unavailable due to the conflicting or contradicting information from the UE's own candidate resource set S_{A} and from the received candidate resource set S_{AIM}. However, in accordance with certain embodiments of the present invention, UE 400 may apply exceptions and consider to include resources into the combined candidate resource set despite the mismatch, i.e., despite the fact that a certain resource is only indicated in one of the own and received candidate resource sets. A first exception is that the further UE 404 informs UE 400 about a certain resource as being available although UE 400 sees this resource to be occupied due to the exposed node problem, where a first UE and a second UE are in each other's vicinity but are transmitting on the same resource to respective receiving UEs that are in opposite directions. Due to the sensing of the transmission on this resource, UE 400 is expected to exclude the resource, but in reality, since the respective receiving UEs are located in different directions, they may actually use the same resource. Therefore, in accordance with such embodiments, despite the fact that a resource is indicated in the received candidate resource set but not in the own candidate resource set, UE 400 may include the resource into the combined candidate resource set.

In accordance with another embodiment, an exception may be applied when the further UE 404 sees a resource to be available, however, due to the fact that it is quite far away from UE 400, the further UE 404 may not realize that this resource is being used by another UE that is closer to UE 400. In a similar way, the further UE may indicate a resource to be available at a certain time, however, the information may be outdated, i.e., at the time of the triggered transmission another UE may actually have reserved the certain resource for its own transmission so that it is no longer available. Thus, in accordance with such embodiments, UE 400 does not include a resource only indicated in the received candidate resource set but not in the own candidate resource set into the combined candidate resource set. Stated differently, in case a resource is indicated only in the received candidate resource set but not in the own candidate resource set, in certain situations the UE may nevertheless decide to include the resource into the combined candidate resource set, but only in case a distance between the UE and the further UE is below a threshold or when a timing of the received candidate resource set is below a certain threshold, i.e., the information from the further UE is not outdated or too old. Otherwise, the information from the received candidate resource set is not used for building the combined candidate resource set. The other factors that may be used by the UE 400 to consider resources from either of the candidate resource sets to be added into the combined candidate resource set are the location, direction and speed of the further UE 404 from which the UE 400 received the AIM, and the time when the AIM was received.

The combined candidate resource set may have a size that is greater than the size Mₜₒₜₐₗ of the UE's own candidate set S_{A}, and UE 400 may randomly select, for example based on a uniform distribution, a required number of resources from the combined candidate resource set for the triggered transmission. Thus, in case the combined candidate resource set includes a number of resources that is above a certain threshold, UE 400 may readily use the combined candidate resource set for the final selection of resources to be used for the actual triggered transmission. On the other hand, in case the number of resources in the combined candidate resource set is below the predefined threshold or does not exceed this threshold, UE 400 repeats the process of resource selection with a higher RSRP threshold value so as to generate a new own candidate resource set, and then the above described process of merging or combining the new candidate resource set with the received candidate resource set included in the AIM is repeated, for example until the number of resources included in the combined candidate resource set is above the predefined threshold. The UE then sends the combined candidate resource set to the higher layers for the random resource selection of resources for the triggered transmission from the combined candidate resource set.

In accordance with other embodiments, in case the received candidate resource set S_{AIM} and the UE's own candidate resource set S_{A} include common resources, UE 400 may only consider these common resource. In case the number of common resources is below or not exceeding a predefined threshold, e.g., in case the number of common resources is not enough for allowing for a sufficient selection of resources for transmission, UE 400 considers other resources either from the own candidate resource set or from the received candidate resource set S_{AIM}. The additional resources from one or more received candidate resource sets included in respective AIMs may be considered by UE 400 based on their origin, like a geo-location, a distance or an ID of the further UE that provided the respective AIM, or based on a timing, i.e., dependent on how old the information is, when the AIM was received and the like, and the UE may select from a plurality of received AIMs the latest or the m-latest AIMs to select additional resources for the candidate resource set.

In accordance with further embodiments, UE 400 may not carry out a sensing process, for example because it was transmitting in a time slot or it was in a DRX mode, so that there are no sensing results available and, as a consequence, there is also no own candidate resource set S_{A}. It is also possible that UE 400 carried out partial sensing over only a few sub intervals of the sensing window, resulting in an incomplete candidate resource set. Due to the low confidence in its own candidate resource set because sensing was carried out for less than a configured or pre-configured minimum percentage or threshold of the entire sensing window, the UE 400 may decide to not use its own candidate resource set. In such a scenario, UE 400 solely makes use of the received candidate resource set S_{AIM} for the final selection of resources for the transmission, i.e., the UE sends the candidate resource set S_{AIM} received in the AIM to the higher layers for the random selection of resources for the triggered transmission. In other words, UE 400 may use the received candidate resource set as its own candidate resource set for the random selection process.

### AIM Containing Specific Resources or a Set of Specific Resources

In accordance with embodiments, in case the AIM includes specific resources or a set of specific resources, UE 400 uses the specific resources without any evaluation or selection process for the UE's own triggered transmission 406. In this scenario, UE 400 does not take into consideration or account its own sensing and selection process but considers only the resources or set of the resources indicated in the AIM. In other words, the UE uses the received set of specific resources for a selection of resources to be used for the transmission regardless of whether the UE performs a resource selection process to obtain an own candidate resource set for the transmission or not.

### AIM Containing Set of not Preferred Resources

In accordance with yet further embodiments of the present invention, the received AIM may include unavailable or occupied resources, for example resources being not free or having a power level above a certain threshold or an interference level above a certain threshold. In other words, the one or more AIMs may include resources that are unavailable and are not to be used by UE 400 for a resource selection process. In accordance with such embodiments, UE 400 understands that the resources provided in the AIM are not favorable to be used for its own triggered transmission 406.

### AIM Containing Candidate Resource Set

Responsive to the triggered transmission, UE 400 performs the process described with reference to FIG. 3 so as to obtain a candidate resource set S_{A}. In case the AIM received at UE 400 includes a candidate resource set S_{AIM} including resources that are not to be used or that are to be avoided by UE 400, in accordance with embodiments, UE 400 excludes those resources indicated in the received candidate resource set S_{AIM} from its own candidate resource set S_{A}.

The UE 400 first evaluates the received candidate resource set S_{AIM} by factoring in the selection weight as described below. The sensing process carried out by UE 400 is not affected by the received AIM, in the sense that UE 400 generates its own candidate resource set S_{A}, independent of any received AIM. UE 400 then proceeds to exclude from its own candidate resource set S_{A} those resources indicated in the received candidate resource set S_{AIM}. In other words, this essentially means that any resources that are overlapping or that are common in the received candidate resource set S_{AIM} and in the UE's own candidate resource set S_{A} are excluded from the final candidate resource set S_{B} which is the candidate resource set that is finally sent to the higher layers for the actual selection of resources to be used for the triggered transmission 406.

In accordance with further embodiments, when excluding common resources, UE 400 may exclude only some of the common resources indicated in both the received candidate resource set S_{AIM} and in the UE's own candidate resource set S_{A}. For example, UE 400 may exclude a certain number of resources, like m resources with m being an integer, like the m worst resources or any m resources that are randomly selected, or any continuous set of m resources. This process may be applied, for example, in case the remaining resources in the final candidate resource set S_{B} drops below a predefined threshold needed for the transmission 406, i.e., there are not enough resources remaining in the final candidate resource set S_{B} after excluding the common resources. Despite the fact that the resources in the received candidate resource set are indicated to be not available, a certain number of such resources, also referred to as bad resources, may nevertheless still be taken into account, like the above mentioned m resources or 10% of the resources indicated in the received candidate resource set. Such resources may still be good enough for a successful transmission due to the channel coding employed. In other words, the applied channel coding may tolerate a certain number of the resources which should actually be excluded from the final candidate resource set S_{B}, so that, for example in case there are not enough resources in the final candidate resource set, at least these additional resources may be used.

In accordance with other embodiments, in case it turns out that the final candidate resource set S_{B} has not enough resources, UE 400 may repeat the resource selection process as described above with reference to FIG. 3 using a higher RSRP threshold value, thereby obtaining a new own candidate resource set S_{A} from which UE 400 then excludes the common resources in the new candidate resource set and the received candidate resource set S_{AIM}, thereby generating the final candidate resource set S_{B}. This process may be repeated until the final candidate resource set S_{B} has a sufficient number of resources for the selection of the actual resources to be used for the transmission 406.

### AIM Containing Specific Resources or a Set of Specific Resources

In accordance with further embodiments, the AIM may include specific resources or a set of specific resources that are to be avoided or are not to be used by UE 400. In accordance with such embodiments, UE 400 excludes these references from its own candidate resource set the UE obtained by performing the sensing and selection process described above with reference to FIG. 3. The AIM may be received by UE 400 even after it has selected resources from its own candidate resource set, in which case, UE 400 excludes the indicated resources from the selected resources.

In case of number resources in the so-generated final candidate resource set S_{B} is below a certain threshold, or when the required number of resources for the triggered transmission 406 is no longer available, UE 400 may request higher layers to select more resources randomly from one or more candidate resource sets previously received by other AIMs and to add the selected resources to the final candidate resource set S_{B} to ensure that a sufficient number of resources required for the triggered transmission 406 is within the final candidate resource set S_{B}. UE 400 then again compares the newly selected resources with the resources provided in the AIM, and in case there are still common resources, they are excluded. UE 400 repeats the process until the final candidate resource set S_{B} no longer includes any of the resources included in the AIM, i.e., the final candidate resource set SB or the final set of selected resources no longer includes resources that are to be avoided by UE 400 for the triggered transmission 406.

In accordance with other embodiments, rather than requesting additional resources from previously received AIM, in accordance with another embodiment, UE 400 may repeat the resource selection process so as to obtain a new candidate resource set, as explained above with reference to FIG. 3. The UE then, in a similar way as described above, compares the resources in the new own candidate resource set with the resources indicated in the AIM and excludes these resources from the new candidate resource set. This may be repeated by UE 400 until a final set of resources or a final candidate resource set S_{B} is obtained that does not include any of the resources indicated by the AIM.

In the above described embodiments in accordance with which the AIM contains a preferred or a not preferred set of resources, i.e., in case the AIM includes a candidate resource set or a specific set of resources, the final selection of resources to be used needs not to be handled at the PHY layer but it may be handled by a higher layer, like the MAC layer. Thus, other than in the case of receiving sensing results, no action in the PHY layer is required, because the candidate resource set created by UE 400 is provided to the MAC layer for the final resource selection, so that the received AIM may remain in the MAC layer and combining/merging or excluding resources may be performed in the MAC layer. In other words, if the received AIM contains a candidate resource set, the MAC layer merges the candidate resource set received from the AIM with the candidate resource set that the UE 400 had generated and sent to the MAC layer. If the received AIM contains a set of specific resources, the MAC layer merges the resources received from the AIM with the set of resources selected by the MAC layer from the candidate resource set that the UE 400 had generated and sent to the MAC layer. The candidate resource sets are merged by the MAC layer depending on the type of resource sets—the resources are constructively combined in the case of a preferred set of resources, and the resources are excluded in the case of a not preferred set of resources. Thus, it is not necessary to forward the AIM from the MAC layer to the PHY layer.

In accordance with any of the embodiments described herein, an AIM or the resources indicated or received in an AIM, like the resources in the sensing results or the preferred/not preferred resources in the candidate resource set S_{AIM} or in the set of specific resources may be evaluated as to whether they have to be considered by the UE 400 in its selection procedure or not. The resources may be evaluated by factoring in a selection weight, which is based on the following aspects:
The source of the AIM, where the intended recipient of the triggered transmission is considered. For example, if the further UE 404 that sent the AIM is the intended recipient of the triggered transmission from the UE 400, the AIM has a higher selection weight as compared to an AIM that was received by other UEs.
The received power of the AIM, where transmissions of the AIM with higher received power (SL-RSRP or SL-RSSI) indicate that the transmitter of the AIM is in close proximity, and has a higher selection weight, as compared to a further UE 404 that is farther away, and the measured received power is much lower.
The location, distance, or speed of the further UE transmitting the AIM, where the closer the further UE 404 is, and traveling towards the direction of the UE 400, has a higher selection weight.
The time the AIM was received, where an older AIM has a lower selection weight as compared to a recently received AIM.

Taking the different selection weights into consideration, the UE 400 may decide to use the received AIM if the combined selection weight is above a configured or pre-configured threshold. In the case where the UE 400 receives multiple AIMs, the UE 400 may use the selection weights to consider only those AIMs that are above the said threshold, or consider only the top-m AIMs that were ranked based on the selection weights.

In accordance with embodiments, when the UE is merging one or more AIM resources with its existing candidate resource set, the selection weight of certain resources may be modified when factoring in the AIM by one or more of:
decreasing the selection probability if a resource is not within the set,
increasing the selection probability if a resource is within the set,
decreasing the selection probability if a resource is within the set,
increasing the selection probability if a resource is not within the set.
decreasing the selection probability if a resource is within a non-preferred set.

### Actions Based on Other Criteria

In accordance with further embodiments, UE 400 may consider to perform certain actions or procedures with regard to a received AIM including resource allocation related assistance information based on one or more of the following criteria:
an intended receiver of the triggered transmission,
priority or power level threshold associated with the report or AIM,
a type or capability of the further UE sending the report or AIM,
a location or zone of the further UE sending the AIM,
a distance of the further UE sending the AIM,
a region within which the further UE sending the AIM is situated in,
the cast type attached to the AIM.

The above criteria and the associated actions/procedures UE 400 may initiate with regard to a received AIM are now described in more detail.

### Actions Based on the Intended Receiver of the Triggered Transmission

The triggered transmission 406 may be directed, as mentioned above, to the destination 410 which may be another UE or a RAN entity, like a RSU or a GL UE. In accordance with embodiments, the destination 410 may be a receiving UE which also provides the AIM, i.e., the receiving UE may be one or more of the further UEs 404 illustrated in FIG. 5. In case the intended receiving UE for the triggered transmission 406 from UE 400 is one of the further UEs 404 that provided an AIM, UE 400 may use the AIM but only resources intended for the transmission 406 to the further UE 404 are used. For example, in case the AIM contains a set of preferred resources, the UE only uses these resources for the transmission 406. In case the UE contains a set of not preferred resources, UE 400 avoids or does not use these resources for the transmission 406. The resources are reported by the further UE 404 in the AIM since the further UE is already aware of its own ongoing transmissions. Thus, the further UE transmits, via the AIM, either explicitly those resources which are collision free, i.e., the set of preferred resources, or, signals to UE 400, via the AIM, the resources not to be selected, i.e., not preferred resources, so as to avoid possible collisions.

In accordance with other embodiments, the intended receiving UE may be not the UE providing the AIM but any other UE. Thus, in case the intended receiving UE for the triggered transmission 406 by UE 400 is any other UE in the vicinity, the resources provided in the AIM by the further UE 404 are based on the further UE's own sensing results that, for example, detect the transmissions to other UEs on these resources. Since UE 400 intends to transmit to the other UEs in the vicinity, using the same resources may cause a higher interference between the transmissions. Thus, in case the AIM includes a set of preferred resources, UE 400 makes use of these resources for the transmission 406 to the other UE, while in case the AIM contains not preferred resources, the UE avoids or does not make use of these resources for the transmission 406.

Actions Based on Priority/SL-RSRP Threshold Associated with the AIM

In accordance with embodiments, the further UE is aware of a priority of the transmissions that are carried out on the resources in the AIM, and a priority value may be included into the AIM, or the control information associated with the AIM, so that UE 400 may determine any actions or procedures to be taken with regard to the AIM accordingly.

### (a) AIM Containing a Set of not Preferred Resources

In accordance with embodiments, in case the AIM contains a set of not preferred resources, UE 400 may consider the AIM and exclude the resources indicated in the AIM only if the triggered transmission 406 is of a priority lower than the priority associated with the resources indicated in the AIM. This is because the AIM indicates resources that are in use by other transmissions, for example, by high priority transmissions, and UE 400 is to avoid using such resources because a new resource selection process is triggered since the triggered transmission 406 is pre-empted by the higher priority transmissions. On the other hand, in case UE 400 has a transmission 406 to be carried out that has a priority higher than the priority indicated in the AIM, UE 400 may use the resources in the AIM, despite the fact that they are actually meant to be excluded, due to the pre-emption mechanism that the other UEs use when detecting the higher priority transmission from UE 400 so that these resources are actually avoided by the other UEs. Note that the UE 400 may use the resources in the AIM, despite the fact that they are actually meant to be excluded, only if pre-emption is enabled for the resource pool in which the intended transmission is to take place.

In accordance with other embodiments, the further UE may include into the AIM the SL-RSRP threshold value that the further UE used for determining the resources to be not preferred, i.e., to indicate which resources are to be avoided. In accordance with such an embodiment, UE 400 compares the SL-RSRP threshold associated with a received AIM against the SL-RSRP threshold UE 400 used when performing the sensing and selection process for the triggered transmission 408, as described above with reference to FIG. 3. In case the threshold indicated in the received AIM is lower than a threshold associated with the triggered transmission 406, UE 400 considers the AIM and excludes resources indicated in the AIM from its own resource set. In case the threshold indicated in the received AIM is higher than a threshold associated with the triggered transmission 406, UE 400 does not consider the AIM and does not exclude resources indicated in the AIM from its own resource set.

In accordance with embodiments, rather than signaling a priority or SL-RSRP threshold in the AIM, a resource pool wide or system wide configuration of the priority or the SL-RSRP threshold may be implemented. In accordance with such embodiments, UE 400 considers a received AIM indicating resources to be avoided and actually excludes the indicated resources from its own candidate resource set only if a priority or SL-RSRP threshold associated with the triggered transmission 406 is lower than the configured or pre-configured priority or SL-RSRP threshold. On the other hand, when the priority or SL-RSRP threshold associated with the transmission 406 of UE 400 is higher than the configured or pre-configured priority or SL-RSRP threshold, UE 400 may not exclude the indicated resources. In accordance with embodiments, the configured or pre-configured priority or SL-RSRP threshold may be included in a resource pool configuration, similar to a priority field used for triggering the pre-emption.

### (b) AIM Containing a Set of Preferred Resources

In case the AIM contains a set of preferred resources, in accordance with embodiments, UE 400 considers the AIM independent or immaterial of any priority or SL-RSRP value associated with the AIM, as long as pre-emption is enabled for the resource pool in which the intended transmission is to take place. UE 400, preferably, looks for one or more AIMs that match the priority of the triggered transmission 406, however, UE 400 may also make use of one or more AIMs that indicate resources of a higher priority since these resources are more reliable for the transmission due to the reduced interference detected on these resources. UE 400 may also make use of one or more AIMs indicating resources of a lower priority, when compared to the UE's own triggered transmission 406, because in this situation the triggered transmission is of a higher priority and any other transmissions occurring on the resources with a lower priority are forced to vacate the resources on detection of the high priority transmission, as handled by the pre-emption procedure. In the case that pre-emption is disabled for the resource pool in which the intended transmission is to take place, the UE 400 will consider the resources indicated in the AIM only if the triggered transmission is of a priority that is equal to or higher than the priority associated with the resources indicated in the AIM.

### Actions Based on a Type of UE Sending the AIM

In accordance with further embodiments, UE 400 may take into consideration the type of the further UE sending an AIM when deciding what action or procedure UE 400 is to perform with regard to the AIM including the resource information.

For example, the further UE may be an RSU, a GL-UE, a relay UE, an IoT device, a wearable or just any other UE. When the type of the further UE sending the AIM is included in the AIM or when the type of the further UE may be identified by UE 400, in accordance with embodiments, a hierarchical priority assignment for each of the UE types is implemented. For example, any type of UE that receives its information from a RAN entity, like a gNB, or from a core network entity has a higher priority than any other UE. For example, a hierarchy based on priority may be as follows: RSU, relay UE, GL UE, Mode 1 UE, Mode 2 UE.

In accordance with other embodiments, the hierarchy may depend on the capabilities of the UE, so that, for example, a low power device, like a wearable or a reduced capability UE, is treated as having a lower priority or being located in a lower rank of the hierarchy, when compared to a power source backed device, like a UE being a part of a vehicle and relying on the vehicle's battery, or a UE having a sufficiently large battery. In the case of the further UE being a power restricted UE or operating in the DRX mode or only carrying out partial sensing, the further UE may also indicate in the AIM that only a reduced sensing is used for obtaining the resource information contained in the AIM and such an AIM may also be treated as having a low priority.

### Location Aspects of the Further UE Sending the AIM

In accordance with an embodiment, the AIM may include a parameter indicating a location of the further UE 404 sending the AIM or a region within which the further UE sending the AIM is located. For example, a zone ID, which refers to the location of the further UE and is included in the SCI format 2-B, or any other parameter may be included as part of the AIM. In case the location information or information about the region is included, UE 400 may determine the distance between UE 400 and the further UE or may determine whether the further UE is within a configured or pre-configured region. On the basis of this information, in accordance with embodiments, UE 400 takes into account only those AIMs that are within a predefined distance to UE 400 or that are within the configured or preconfigured region. For example because UE 400 moves into a certain area or location, UE 400 may consider only AIMs from this area. EU 400 may also determine to use an AIM dependent on the distance using a configured or pre-configured minimum distance within which it considers a received AIM.

In accordance with embodiments, the information from the AIM, like the sensing results or the preferred/not preferred resources, may be used for a transmission 406 even in case UE 400 does not have any own sensing results, for example because it was transmitting during a certain time slot or was in a DRX mode and did not carry out any sensing process. In accordance with embodiments, a validity area or region around the further UE that transmits the AIM is implemented. Within this region UE 400 relies on the content of the AIM for selecting resources for the transmission 406 to any UE that is located within the validity region. This is similar to the minimum communication range field included in the SCI format 2-B, and the parameter mandates that the AIM may only be relied on for the transmission 406 to one or more UEs other than the AIM transmitting UE if the respective positions are known. The parameter may be defined at a system level, at a resource pool level, at a source level, or at a transmission level.

### Actions Based on the Cast Type

In accordance with further embodiments, the AIM provided by a further UE may also indicate the cast type, i.e., whether the AIM is a unicasted AIM, a group-casted AIM or a broadcasted AIM. Dependent on the cast type, the UE may weight the AIM, for example, a unicasted AIM that is meant to be exclusively used for UE 400 is weighted higher than a group-casted AIM that is meant exclusively for a certain group of UEs, and also higher than a broadcasted AIM, like an AIM meant for any UE receiving the AIM. In accordance with other embodiments, the group-casted AIM may be weighted higher than the unicasted AIM which, in turn, is still weighted higher than the broadcasted AIM.

### Forwarding or Duplicating AIMs

In accordance with further embodiments, UE 400 that receives an AIM containing resource information, like a set of preferred or not preferred resources or the sensing results, may forward the AIM to one or more other UEs in the vicinity, either by duplicating the AIM or by sending a redundancy version of the AIM. In case the AIM includes a cast type, UE 400 may change the cast type as follows:
from unicast to groupcast, or
from unicast to broadcast, or
from groupcast to unicast, or
from groupcast to broadcast, or
from broadcast to unicast, or
from broadcast to groupcast.

The AIM may contain information relating to one or more high priority transmissions, and any UE in the vicinity of UE 400 may be looking for additional AIMs for assisting any high priority transmissions. Therefore, forwarding an AIM by UE 400 is useful.

In accordance with embodiments, the AIM may include a hop count or a validity timer defining whether the AIM may still be forwarded by UE 400 or not. This may be useful in case UE 400 forwards the AIM to another UE as well as to another network entity, like an RSU or an infrastructure node, like a gNB or a small cell. The latter may forward the AIM to the core network, like the 5GC, so as to allow for a possible reaction by the core network. The core network may collect and evaluate AIMs and consequently reconfigure network parameters or network entities accordingly. For example, the core network may derive resource utilization by comparing AIMs received from the same or a set of network entities. If it finds the network utilization too high, it may configure more resource pools to be used by Mode 2 UEs. For this, it might be required to evacuate spectrum previously used for Mode 1 UEs. Here, similar approaches used for systems implementing licensed assisted access (LAA) or licensed shared access (LSA) may be used to free-up spectrum for Mode 2 UEs. In another example, the 5GC may evaluate spectrum to be under-utilized. Here, the 5GC may trigger to reduce the number of resource pools to be used by Mode 2 UEs by providing updated resource pool configurations to be used by Mode 2 UEs. This enables a more efficient and flexible spectrum usage, also in shared access scenarios where Mode 1 and Mode 2 UEs coexist. In another example, the 5GC may plainly use SL AIMs to track UEs within its network. This may be done if SL AIMs contain reference to a physical location of an UE, e.g. a geo-location or a zone ID. For example, when considering an industrial communication scenario, the UEs may be IoT devices operating in mode 2 and forwarding AIMs to the 5GC campus network. If the network notices a lack of resources for certain IoT devices by evaluating received AIMs, it may reconfigure certain IoT devices or groups of IoT devices to change operating mode to mode 1, if possible, so that a certain QoS for these devices may be maintained.

Also, providing the AIM with a hop count allows tracing the AIM within the network so as to check whether AIMs distributed in the network are consistent. The mechanism may be advantageous as it helps to identify malicious activity in the network, for example situations when a certain UE starts flooding the network with AIMs.

The UE may choose to duplicate or send a redundancy version of the AIM, and a UE, like UE 400, receiving multiple versions of an AIM may combine the redundancy versions of an AIM to as to increase the reliability of reception, like decoding, of the one or more AIMs.

### Receiving a Plurality of AIMs

In accordance with embodiments, UE 400 may receive a plurality of AIMs from different further UEs for the same triggered transmission 406. In accordance with such embodiments, UE 400 may consider an AIM based on one or more of the following hierarchical conditions:
Priority or SL-RSRP threshold:
   UE 400 may consider only AIMs that are associated with the same or a higher priority or with the same or a higher SL-RSRP threshold when compared to the triggered transmission.
Source of the AIM:
   UE 400 may consider an AIM, in case it was transmitted from the same UE to which the triggered transmission 406 is directed to. In other words, in case the further UE is the intended recipient of the triggered transmission 406, UE 400 considers the AIM received from the further UE with higher importance when compared to AIMs sent by other further UEs.
Distance or geo-location or speed:
   UE 400 may only consider the AIM or those UEs that are within a certain range or at a certain distance, or those UEs moving in the same direction as UE 400 or moving in an opposite direction as UE 400, or UEs moving within a similar speed as UE 400 or moving at a speed substantially lower than UE 400, like a pedestrian UE, or only those AIMs associated with UEs moving at a fast speed, like participants of an illegal road race, or it may only consider AIMs provided by a green-light authority, like first responders, for example police, ambulance, fire department.

Another option for the UE 400 to consider only relevant AIMs from the multiple AIMs received is by using the selection weights that are factored in for each of the AIMs, as described above. The AIMs with the highest selection weight may be considered over the other AIMs. This may be done by using the selection weights to consider only those AIMs that are above a configured or pre-configured threshold, or consider only the top-m AIMs that were ranked based on the selection weights.

In accordance with further embodiments, UE 400 may signal that no more AIMs are to be sent or that a period of sending AIMs is to be increased for a certain time, when a number of received AIMs reaches or exceeds a threshold. This may indicate situations in which a malicious UE transmits multiple AIMs or to situations in which an AIM flooding occurs. UE 400 may be provided with a sufficient priority so as to have the possibility to send the above mentioned stop AIM message either as a unicast message, as a broadcast message, or as a group-cast message, which indicates that no more AIMs of a given type are to be sent or that the period of sending AIMs for a certain time is increased, thereby avoiding the flooding with AIMs. For example, the further UE 404 may receive a message telling it to send an AIM not every ten seconds but every minute, or to stop or pause sending an AIM for a certain time or until receiving a signaling to resume the sending of AIMs. In accordance with other embodiments, rather than telling the origin of the AIM to send the AIM only every minute, the origin of the AIM may be instructed to send an AIM only in case the further UE has data to transmit, and then the AIM may be piggybacked onto the data transmission, thereby also reducing the number of AIMs being transmitted. On the contrary, a UE 400 may also signal to another UE to provide AIMs more frequently in case it does not receive enough AIMs within a certain time period,

In accordance with further embodiments, an AIM flooding may be reduced by introducing, for example, an AIM limit. If there are more than a certain number of AIMs of a certain type received in a time period, no further AIMs of this type may be considered by UE 400, at least for a certain time. In accordance with embodiments, the limit may also be staggered so as to limit different types of AIMs or AIMs having associated different priorities at different occupancy levels. In accordance with yet other embodiments, when the number of AIMs received at UE 400 exceeds a certain threshold, UE 400 may only consider AIMs in a configured or preconfigured default periodicity and ignore any remaining AIMs. This means that, in case UE 400 is receiving multiple AIMs but transmits only periodic transmissions, UE 400 may ignore all the AIMs between the periodic transmissions and only decode those that it needs for the periodic transmissions. Another scenario is that independent or immaterial of the UEs intended transmission, if UE 400 receives many AIMs, it may decide to use only a few of them periodically. This may also be considered as a kind of power saving mechanism. For example, when considering a situation in which UE 400 needs an AIM every ten seconds so as to obtain updated information, once the UE received the AIM fulfilling that requirement, UE 400 may stop receiving or considering other AIMs for the next ten seconds.

### General

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

Although some of the embodiments above are described with reference to a Mode 2 UE, it is noted that the present invention is not limited to such embodiments. The teachings of the present invention as described herein are equally applicable to Mode 1 UEs carrying out sensing to obtain, e.g., a sensing report for providing an occupancy status of one or more resources or resource sets and transmitting AIMs. For example, Mode 1 UEs may aid in performing sensing for Mode 2 UEs, e.g. if operating in the same frequency band. A mode 1 UE may also be a fixed RSU which has a wired power supply, and which may, if idling in mode 1, perform services for mode 2 UEs.

Although some of the embodiments above are described with reference to a sidelink pool, it is noted that the present invention is not limited to such embodiments. Rather, the inventive approach may be implemented in a system or network providing a set or resources to be used for a certain communication between entities in the network, and the set of resources may be preconfigured so that the entities of the network are aware of the set of resources provided by the network, or the entities may be configured by the network with the set of resources. The set of resources provided by the network may be defined as one or more of the following:
a sidelink resource pool, to be used by the UE for sidelink communications, e.g. direct UE-to-UE communication via PC5,
a configured grant including or consisting of resources to be used by the UE for NR-U communications,
a configured grant including or consisting of resources to be used a reduced capability UE.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

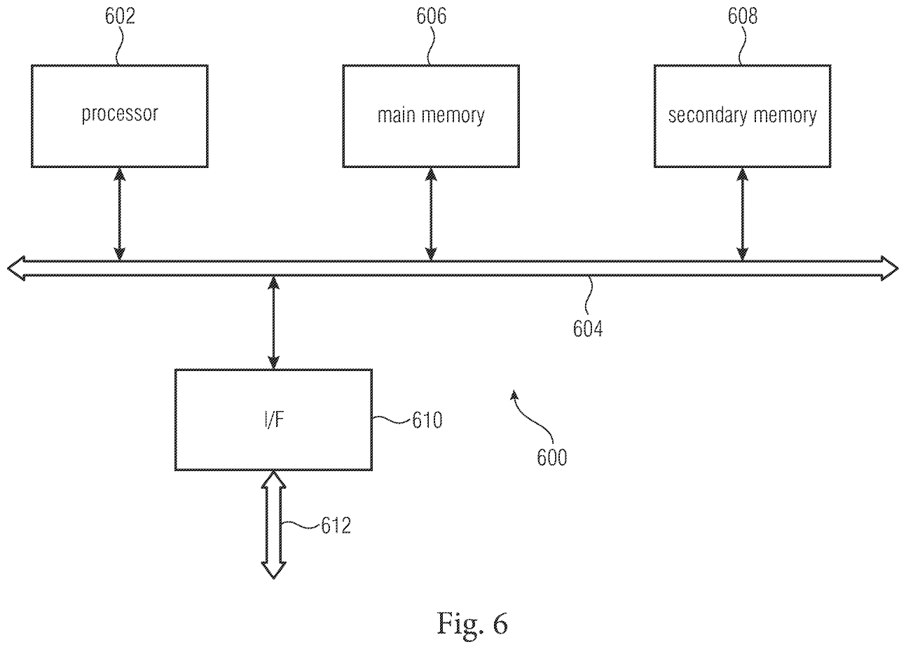

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 6 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A user device, UE, for a wireless communication network, the wireless communication network comprising a plurality of user devices, UEs,
wherein the UE is to communicate with one or more network entities of the wireless communication network, like a base station or another UE,
wherein, responsive to a trigger for a transmission, the UE is to acquire resources for the transmission,
wherein the UE is to receive from one or more further UEs one or more reports or assistance information messages, AIMs, the report or AIM comprising resource allocation related assistance information, and
wherein, dependent on a type of resource allocation related assistance information comprised in the received report or AIM and/or dependent on a certain criterium, the UE is to decide how to use the received report or AIM for acquiring resources for the transmission.

2. The user device, UE, of claim 1, wherein the type of resource allocation related assistance information comprises one or more of
sensing results, the sensing results comprising a plurality of resources within a sensing window of the further UE and measured power levels, e.g., the measured Reference Signal Received Power, RSRP, associated with the respective resources,
a candidate resource set, the candidate resource set comprising a set of available/preferred or unavailable/not preferred resources within a selection window of the further UE,
one or more specific resources, the one or more specific resources comprising one or more resources to be used for a transmission by the UE, wherein
the one or more resources are selected from a candidate resource set acquired by the further UE, and/or
the one or more resources are reserved by the further UE, but remain unused.

3. The user device, UE, of claim 1, wherein, when the type of resource allocation related assistance information comprises sensing results that are that are valid for the transmission, the UE is to consider some or all of the received sensing results for acquiring resources for the transmission.

4. The user device, UE, of claim 3, wherein the sensing results are valid for the transmission when one or more of the following applies:
the sensing results are within a sensing window of the UE,
the sensing results are not older than a certain timestamp, e.g. where the timestamp is compared to the time the AIM was received by the UE,
the start or end of the sensing window used by the further UE to generate the sensing results, are not older than a configured or pre-configured time instance,
the sensing results are acquired within a certain distance from the UE or within a certain geo-location or region,
an origin of the sensing results is a particular network entity, e.g. a further UE with a certain ID, a GL-UE, an RSU,
the sensing results are confirmed by another sensing result.

5. The user device, UE, of claim 3, wherein the received sensing results comprise one or more of the following:
power levels, like Reference Signal Received Power, RSRP, values, of the resources measured by the further UE when carrying out sensing, or
an indication whether the resources acquired by the further UE when carrying out sensing are occupied or unoccupied, e.g., based on a comparison between a threshold, like a RSRP threshold, and a power level, like an RSRP values measured by the further UE in the given resource, or
a list of unoccupied resources, like resources comprising a power level, like an RSRP, value measured by the further UE below a threshold, like a RSRP threshold, or
a list of occupied resources, like resources comprising a power level, like an RSRP value, measured by the further UE above a threshold, like an RSRP threshold.

6. The user device, UE, of claim 3, wherein the UE is to consider only some of the received sensing results for acquiring resources for the transmission, for example
a predefined number of resources comprising the least measured power level, or
the first m or top-m resources indicated in the AIM, with m being an integer, or
resources indicated by a certain UE, e.g., based on an ID or a capability or a type of the UE.

7. The user device, UE, of claim 3, wherein the UE is to acquire own sensing results during a sensing window preceding the trigger, and when one or more of the own sensing results concern resources indicated in the received sensing results, the UE is to carry out one of the following actions;
ignore the received sensing results and consider only the own sensing results,
ignore the own sensing results and consider only the received sensing results,
merge the own sensing results and the received sensing results, e.g., by:
taking an average or minimum or maximum of the power levels measured on a resource by UE and by the further UE,
weighting the received sensing results with a probability, thereby making them less or more relevant than the own sensing results.

8. The user device, UE, of claim 3, wherein, in case the UE comprises no own sensing results during a sensing window preceding the trigger, the UE is to consider all of the received sensing results for acquiring resources for the transmission.

9. The user device, UE, of claim 3, wherein the UE is to provide a received AIM from the MAC layer to the PHY layer for comparing the sensing results measured by the UE on the PHY layer and the sensing results in the AIM.

10. The user device, UE, of claim 1, wherein
when the type of resource allocation related assistance information comprises a set of available or preferred resources within a selection window of the further UE, the UE is to use some or all of the resources from the received set of available or preferred resources,
responsive to the trigger, the UE is to perform a resource selection process to acquire an own candidate resource set for the transmission, and
when the set of available or preferred resources comprises a candidate resource set, the UE is to add to the own candidate resource set some or all resources that are indicated in the received candidate resource set and that are within a selection window of the UE.

11. The user device, UE, of claim 10, wherein
the UE is to form a combined candidate resource set to be used for the resource selection for the transmission, the combined candidate resource set being acquired by selectively combining resources from the own candidate resource set and from the received candidate resource set, and
the UE is to combine the resources from the own candidate resource set and from the received candidate resource set as follows:
if a resource is indicated in both of the own and received candidate resource sets, the UE is to include the resource to the combined candidate resource set, and
if a resource is indicated in only one of the own and received candidate resource sets, the UE is not to include the resource to the combined candidate resource set, or.
if a resource is indicated in both of the own and received candidate resource sets, the UE is to include the resource to the combined candidate resource set,
if a resource is indicated in the own candidate resource set but not in the received candidate resource set, the UE is to not include the resource into the combined candidate resource set, and
if a resource is indicated in the received candidate resource set but not in the own candidate resource set, the UE is to include the resource into the combined candidate resource set, or
if a resource is indicated in both of the own and received candidate resource sets, the UE is to include the resource to the combined candidate resource set,
if a resource is indicated in the own candidate resource set but not in the received candidate resource set, the UE is to include the resource into the combined candidate resource set, and
if a resource is indicated in the received candidate resource set but not in the own candidate resource set, the UE is to not include the resource into the combined candidate resource set.

12. The user device, UE, of claim 10, wherein the UE is to combine the resources from the own candidate resource set and from the received candidate resource set by including resources into the combined candidate resource set that are common to both of the own and received candidate resource sets.

13. The user device, UE, of claim 10, wherein, in case the UE does not perform a resource selection process, or in case the UE does perform only partial sensing and/or does not comprise sensing results pertaining to the selection window, responsive to the trigger and when the set of available or preferred resources comprises a candidate resource set, the UE is to provide the received candidate resource set for a selection of resources for the transmission.

14. The user device, UE, of claim 1, wherein
when the type of resource allocation related assistance information comprises a set of unavailable or not preferred resources within a selection window of the further UE, the UE is not to use the resources from the received a set of unavailable or not preferred resources, and
responsive to the trigger, the UE is to perform a resource selection process to acquire an own candidate resource set for the transmission, and
when the set of unavailable or not preferred resources comprises a candidate resource set, the UE is to exclude from the own candidate resource set some or all of the resources that are also indicated in the received candidate resource set, or

15. The user device, UE, of claim 14, wherein
when the type of resource allocation related assistance information comprises a set of unavailable or not preferred resources within a selection window of the further UE, the UE is not to use the resources from the received a set of unavailable or not preferred resources, and
responsive to the trigger, the UE is to perform a resource selection process to acquire a candidate resource set for the transmission,
when the set of unavailable or not preferred resources comprises a set of specific resources, the UE is to exclude from the candidate resource set the received set of specific resources, the set of specific resources comprising one or more resources selected from a candidate resource set acquired by the further UE and not to be used for the transmission by the UE.

16. The user device, UE, of claim 15, wherein
in case a number of resources is below a predefined threshold after excluding the received set of specific resources, the UE is to
(a) request, e.g., higher layers, to select additional resources for the transmission randomly from one or more previously received AIMs, like a previous candidate resource set, and to add the selected resources to the candidate resource set, thereby acquiring a new candidate resource set,
(b) exclude from the new candidate resource set the set of specific resources,
(c) repeat (a) and (b) until the new candidate resource set does not include any of the specific resources, or
responsive to the trigger, the UE is to perform a resource selection process to acquire a final set of resources to be used for the transmission,
after acquiring the final set of resources, the UE is to receive the set of unavailable or not preferred resources AIM, and
the UE is to exclude from final set of resources the received set of specific resources.

17. The user device, UE, of claim 1, wherein the certain criterion comprises one or more of the following:
an intended receiver of the triggered transmission,
priority or power level threshold associated with the report or AIM,
a type or capability of the further UE sending the report or AIM,
a location or zone of the further UE sending the AIM,
a distance of the further UE sending the AIM,
a region within which the further UE sending the AIM is situated in,
a cast type attached to the AIM.

18. The user device, UE, of claim 17, wherein
in case the intended receiver of the triggered transmission is the further UE sending the AIM, the UE is
to use the resources indicated in the AIM only for the transmission to the further UE, in the case that the AIM comprises a set of preferred resources, or
not to use the resources indicated in the AIM for the transmission to the further UE, in the case that the AIM comprises a set of not preferred resources, or
in case the intended receiver of the triggered transmission is another UE not sending the AIM, the UE is
to use the resources indicated in the AIM for the transmission to the other UE, in the case that the AIM comprises a set of preferred resources, or
not to use the resources indicated in the AIM for the transmission to the other UE, in the case that the AIM comprises a set of not preferred resources.

19. A wireless communication system, comprising one or more user devices, UEs, of claim 1.

20. A method for operating a user device, UE, for a wireless communication network, the wireless communication network comprising a plurality of user devices, UEs, wherein the UE is to communicate with one or more network entities of the wireless communication network, like a base station or another UE, the method comprising:
responsive to a trigger for a transmission, acquiring resources for the transmission
receiving from one or more further UEs one or more reports or assistance information messages, AIMs, the report or AIM comprising resource allocation related assistance information, and
dependent on a type of resource allocation related assistance information comprised in the received report or AIM and/or dependent on a certain criterium, deciding how to use the received report or AIM for acquiring resources for the transmission.
